(19) United States
(12) Patent Application Publication
(10) Pub. No.: US 2022/0091488 A1
(43) Pub. Date: Mar. 24, 2022

(54) LASER PROJECTION APPARATUS

(71) Applicant: Hisense Laser Display Co., Ltd., Qingdao, Shandong (CN)

(72) Inventor: Naiwen HOU, Qingdao, Shandong (CN)

(73) Assignee: Hisense Laser Display Co., Ltd., Qingdao, Shandong (CN)

(21) Appl. No.: 17/420,085

(22) PCT Filed: Jul. 29, 2020
(86) PCT No.: PCT/CN2020/105532

§ 371 Date: Jun. 30, 2021

(30) Foreign Application Priority Data
Nov. 19, 2019 (CN) 201911136299.2
Nov. 19, 2019 (CN) 201911137406.3
Nov. 19, 2019 (CN) 201922007541.8
Nov. 19, 2019 (CN) 201922011797.6
Nov. 19, 2019 (CN) 201922011798.0

(51) Int. Cl. G03B 21/14; G03B 21/00; G03B 21/20; G03B 21/28; G03B 21/16

(52) U.S. Cl. CPC G03B 21/142; G03B 21/008; G03B 21/208; G03B 21/16; G03B 21/28; G03B 21/2033; G03B 21/2066

(57) ABSTRACT

A laser projection apparatus includes a laser source, an optical engine and a projection lens. The optical engine includes a housing, a light pipe, a lens assembly, a reflector, a prism assembly, a digital micromirror device and at least one prism fixing member. The at least one prism fixing member is configured to fix the prism assembly on the housing, so that a relative position of the prism assembly to the projection lens is kept fixed.

### CROSS-REFERENCE TO RELATED APPLICATIONS

This application is a national phase entry under 35 USC 371 of International Patent Application No. PCT/CN2020/105532 filed on Jul. 29, 2020, which claims priorities to Chinese Patent Application No. 201911136299.2, filed on Nov. 19, 2019, Chinese Patent Application No. 201911137406.3, filed on Nov. 19, 2019, Chinese Patent Application No. 201922011798.0, filed on Nov. 19, 2019, Chinese Patent Application No. 201922011797.6, filed on Nov. 19, 2019, and Chinese Patent Application 201922007541.8, filed on Nov. 19, 2019, all of which are incorporated herein by reference in their entireties.

### TECHNICAL FIELD

The present disclosure relates to the field of projection display technologies, and in particular, to a laser projection apparatus.

### BACKGROUND

A laser projection apparatus is a projection apparatus with laser beams as a laser source. It usually includes a laser source assembly, an illumination assembly, and an imaging assembly. Laser beams generated by the laser source assembly irradiate the imaging assembly after passing through the illumination assembly, and images may be displayed on an object (a screen or a wall) by means of the imaging assembly.

The laser source assembly may typically include a laser array, and the imaging assembly may typically include a projection lens. The illumination assembly typically includes a plurality of lenses, a plurality of prisms, and at least one digital micromirror device (DMD). The laser beams emitted by the laser source assembly sequentially enter the plurality of lenses and the plurality of prisms, then are projected on the digital micromirror device for image signal modulation, and finally are reflected by the digital micromirror device to the projection lens for projection imaging through the projection lens.

### SUMMARY

Some embodiments of the present disclosure provide a laser projection apparatus. The laser projection apparatus includes: a laser source configured to provide illumination beams; an optical engine configured to modulate the illumination beams based on image signals to form projection beams; and a projection lens configured to project the projection beams for imaging. The optical engine includes: a housing, a light pipe, a lens assembly, a reflector, a prism assembly, a digital micromirror device and at least one prism fixing member. The housing encloses an accommodating cavity, and at least the light pipe, the lens assembly, the reflector, and the prism assembly are located in the accommodating cavity. The light pipe is configured to receive the illumination beams and homogenize the illumination beam. The lens assembly is configured to first amplify the homogenized illumination beams, and then converge the amplified illumination beams and emit the converged illumination beams to the reflector. The reflector is configured to reflect the illumination beams to the prism assembly. The digital micromirror device includes a beam receiving surface facing the prism assembly, and is configured to modulate the illumination beams based on the image signals to form the projection beams. The prism assembly is configured to propagate the illumination beams to the beam receiving surface of the digital micromirror device, and receive projection beams reflected by the beam receiving surface, and propagate the projection beams to the projection lens. The at least one prism fixing member is configured to fix the prism assembly on the housing, so that a relative position of the prism assembly to the projection lens is kept fixed.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, and are not limitations on an actual size of a product, an actual process of a method and actual timings of signals to which the embodiments of the present disclosure relate.

FIG. 1 is a schematic diagram showing a simplified structure of a laser projection apparatus, in accordance with some embodiments of the present disclosure;

FIG. 2 is a schematic diagram showing an overall structure of the laser projection apparatus shown in FIG. 1;

FIG. 3 is a schematic diagram showing a structure of an optical engine and a projection lens in the laser projection apparatus shown in FIG. 2;

FIG. 4 is another schematic diagram showing a structure of the optical engine and the projection lens in the laser projection apparatus shown in FIG. 2;

FIG. 5 is a schematic diagram showing an arrangement of micromirrors in a digital micromirror device in the optical engine shown in FIG. 3;

FIG. 6 is a schematic diagram showing a swing position of a micromirror in the digital micromirror device shown in FIG. 5;

FIG. 7 is a schematic diagram showing a beam path of a laser projection apparatus, in accordance with some embodiments of the present disclosure;

FIG. 8 is a top view of the beam path shown in FIG. 7;

FIG. 9 is a schematic diagram showing a beam path of a prism assembly in a laser projection apparatus, in accordance with some embodiments of the present disclosure;

FIG. 10 is a schematic diagram showing a beam path of a prism assembly in another laser projection apparatus, in accordance with some embodiments of the present disclosure;

FIG. 11 is a schematic diagram showing a partial structure of a laser projection apparatus, in accordance with some embodiments of the present disclosure;

FIG. 12 is a bottom view of a prism assembly in a laser projection apparatus, in accordance with some embodiments of the present disclosure;

FIG. 13 is a schematic diagram showing a structure of a prism fixing member, in accordance with some embodiments of the present disclosure;

FIG. 14 is a schematic diagram showing an assembly structure of the prism fixing member shown in FIG. 13 and a second prism;

FIG. 15 is a schematic diagram showing a structure of another prism fixing member, in accordance with some embodiments of the present disclosure;

FIG. 16 is a schematic diagram showing an assembly structure of the prism fixing member shown in FIG. 15 and the second prism;

FIG. 17 is a schematic diagram showing a structure of an optical engine in a laser projection apparatus, in accordance with some embodiments of the present disclosure;

FIG. 18 is a top view of a heat dissipation surface of a digital micromirror device, in accordance with some embodiments of the present disclosure;

FIG. 19 is a schematic diagram showing a structure of the optical engine shown in FIG. 17 from one angle;

FIG. 20 is a schematic diagram showing a structure of the optical engine shown in FIG. 17 from another angle;

FIG. 21 is a schematic diagram showing a structure in which a cooling component is separated from the optical engine shown in FIG. 19 or 20;

FIG. 22 is a top view of the optical engine shown in FIG. 17;

FIG. 23 is a schematic diagram showing a structure of a first screw in the optical engine shown in FIG. 17;

FIG. 24 is a top view of a fixing plate in the optical engine shown in FIG. 22;

FIG. 25 is a schematic diagram showing a structure of a second screw in the optical engine shown in FIG. 17;

FIG. 26 is a top view of a cooling component in the optical engine shown in FIG. 22;

FIG. 27 is an exploded view of the optical engine shown in FIG. 21;

FIG. 28 is a top view of a laser projection apparatus with a top of a housing of an optical engine removed in a normal use state, in accordance with some embodiments of the present disclosure;

FIG. 29 is a schematic diagram showing a structure of a lens assembly fixing device and a light pipe fixing device, in accordance with some embodiments of the present disclosure;

FIG. 30 is a schematic diagram showing a bottom of the housing shown in FIG. 29;

FIG. 31 is a schematic diagram showing a structure of a fixing assembly and a light pipe bearing assembly in a laser projection apparatus, in accordance with some embodiments of the present disclosure;

FIG. 32 is a schematic diagram showing a structure of a light pipe bearing assembly in a laser projection apparatus, in accordance with some embodiments of the present disclosure;

FIG. 33 is another schematic diagram showing a structure of the light pipe bearing assembly in the laser projection apparatus, in accordance with some embodiments of the present disclosure;

FIG. 34 is a schematic diagram showing a structure of a fixing assembly in a laser projection apparatus, in accordance with some embodiments of the present disclosure;

FIG. 35 is a schematic diagram showing an increase in the number of pixels of an image projected by a laser projection apparatus when a vibrating lens is periodically vibrated;

FIG. 36 is a schematic diagram showing a perspective structure of a vibrating lens and a vibrating lens bracket in FIGS. 4 and 28;

FIG. 37 is a schematic diagram showing an exploded structure of the vibrating lens and the vibrating lens bracket shown in FIG. 36;

FIG. 38 is a schematic diagram showing a structure of a first flexible pad or a second flexible pad in FIG. 37;

FIG. 39 is a schematic sectional view of the vibrating lens and the vibrating lens bracket in FIG. 37 after they are fixed; and

FIG. 40 is a schematic sectional view of the vibrating lens bracket in FIG. 37 and a housing after they are fixed.

### DETAILED DESCRIPTION

In order to make a purpose, technical solutions, and advantages of the present disclosure clearer, embodiments of the present disclosure will be described in further detail below in combination with accompanying drawings.

Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, the term “comprise” and other forms thereof such as the third-person singular form “comprises” and the present participle form “comprising” throughout the description and the claims are construed as open and inclusive, i.e., “including, but not limited to”.

In the description, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, features defined as “first” and “second” may explicitly or implicitly include one or more of the features.

In the description of the embodiments of the present disclosure, the term “a plurality of” means two or more unless otherwise specified.

The expression “at least one of A, B and C” includes the following combinations of A, B and C: only A, only B, only C, a combination of A and B, a combination of A and C, a combination of B and C, and a combination of A, B and C. The expression “A and/or B” includes the following combinations: only A, only B, and a combination of A and B.

The term “about” or “approximately” as used herein includes a stated value and an average value within an acceptable range of deviation of a particular value. The acceptable range of deviation is determined by a person of ordinary skill in the art, considering measurement in question and errors associated with measurement of a particular quantity (i.e., limitations of a measurement system).

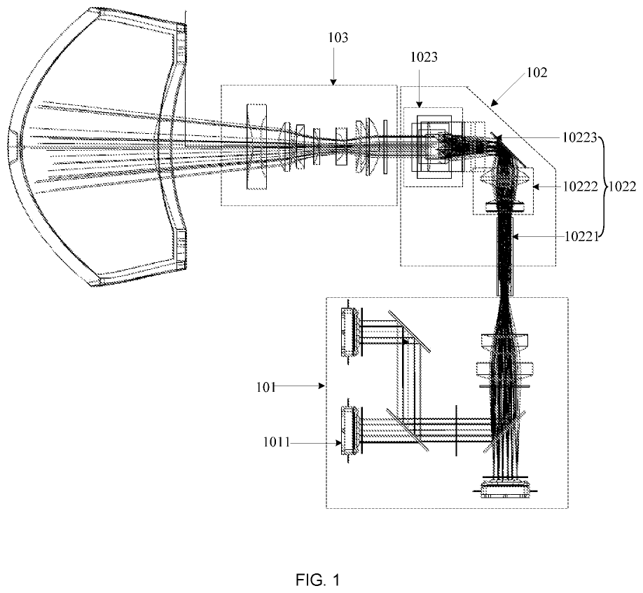

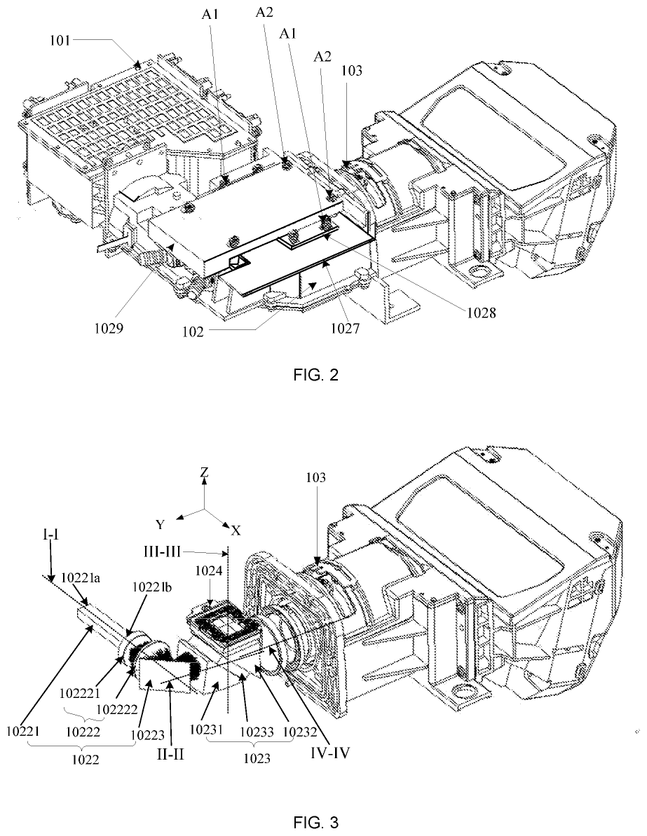

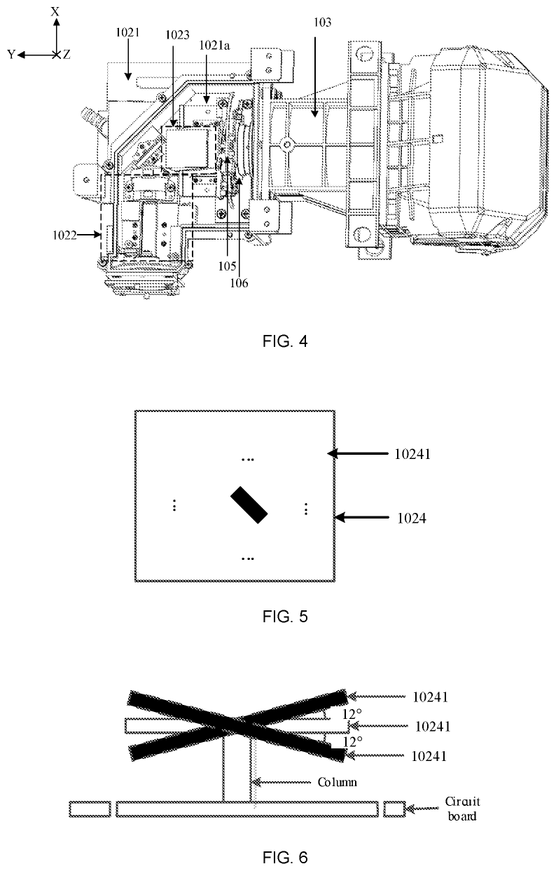

FIG. 1 is a schematic diagram showing a simplified structure of a laser projection apparatus, in accordance with some embodiments of the present disclosure. FIG. 2 is a schematic diagram showing an overall structure of the laser projection apparatus shown in FIG. 1. FIG. 3 is a schematic diagram showing a structure of an optical engine and a projection lens in the laser projection apparatus shown in FIG. 2. FIG. 4 is another schematic diagram showing a structure of the optical engine and the projection lens in the laser projection apparatus shown in FIG. 2. Referring to FIGS. 1 and 2, the laser projection apparatus includes a laser source 101, the optical engine 102 and the projection lens 103.

The laser source 101 is configured to provide illumination beams (laser beams). The optical engine 102 is configured to modulate the illumination beams provided by the laser source 101 with image signals to obtain projection beams. The projection lens 103 is configured to project the projection beams obtained by modulating the illumination beams on a screen or a wall for imaging.

Referring to FIG. 1, the laser source 101 includes three laser arrays 1011. The three laser arrays 1011 may be a red laser array, a green laser array, and a blue laser array respectively. That is, the laser source 101 is a tri-color laser source, but is not limited thereto. The three laser arrays 1011 may also all be blue laser arrays, or, two blue laser arrays and one red laser array.

In some embodiments, the laser source 101 may also include two laser arrays 1011 (a dual-color laser source) or one laser array 1011 (a mono-color laser source). In the dual-color laser source, the two laser arrays 1011 may be a blue laser array and a red laser array. In the mono-color laser source, the one laser array 1011 may be a blue laser array. In some embodiments, the two laser arrays 1011 included in the laser source 101 may both be blue laser arrays.

In a case where the laser source 101 includes only the blue laser array(s), or only the blue laser array(s) and the red laser array, the laser source 101 may further include a phosphor wheel and a color filter wheel. After a blue laser array emits blue laser beams, some of the blue laser beams hit the phosphor wheel to generate red fluorescent beams (in a case where the laser source 101 includes the red laser array, the red fluorescent beams do not need to be generated) and green fluorescent beams. Then, the blue laser beams, the red fluorescent beams (or red laser beams) and the green fluorescent beams may be filtered through the color filter wheel, and then beams of three primary colors are sequentially output. According to a trichromatic mixing principle, human eyes are unable to distinguish the colors of the beams at a certain instance, and what are perceived by the human eyes are still mixed white beams.

The illumination beams emitted by the laser source 101 enter the optical engine 102. Referring to FIGS. 1 and 3, the optical engine 102 includes a beam adjustment assembly 1022, a prism assembly 1023 and a digital micromirror device (DMD) 1024. The beam adjustment assembly 1022 may include a light pipe 10221, a lens assembly 10222, and a reflector 10223.

Referring to FIGS. 1 and 3, the light pipe 10221 is adjacent to the laser source 101, and is configured to receive the illumination beams provided by the laser source 101 and homogenize the illumination beams. Referring to FIG. 3, the light pipe 10221 may include a beam inlet 10221a and a beam outlet 10221b. The illumination beams from the laser source 101 enter the light pipe 10221 from the beam inlet 10221a, and then are emitted from the beam outlet 10221b to the lens assembly 10222 after being homogenized by the light pipe 10221.

With continued reference to FIGS. 1 and 3, in the optical engine 102, the lens assembly 10222 is located between the beam outlet 10221b of the light pipe 10221 and the reflector 10223, and is configured to first amplify the illumination beams homogenized by the light pipe 10221, and then converge the amplified illumination beams and emit the converged illumination beams to the reflector 10223. The reflector 10223 is located between the lens assembly 10222 and the prism assembly 1023, and is configured to reflect the illumination beams that are first amplified and then converged by the lens assembly 10222 to the prism assembly 1023. The beams passing through the prism assembly 1023 finally enter the projection lens 103.

In some embodiments, the light pipe 10221 and the lens assembly 10222 may be configured to shape the illumination beams, that is, to adjust a shape and a size of a beam spot formed by the illumination beams, so that after the illumination beams entering the prism assembly 1023 exit from the prism assembly 1023, they may be incident on a beam receiving surface 1024a of the DMD 1024 with a beam spot whose shape and size are matched with (e.g., the same as) the beam receiving surface 1024a of the DMD 1024. For example, the light pipe 10221 may adjust a circular beam spot emitted by the beam adjustment assembly 1022 into a rectangular beam spot, and a shape of the rectangular beam spot is matched with a shape of the beam receiving surface 1024a of the DMD 1024. The above matching may be that the rectangular beam spot completely covers the beam receiving surface 1024a of the DMD 1024. For example, an area of the rectangular beam spot is equal to an area of the beam receiving surface 1024a of the DMD 1024. For this reason, in some embodiments, a product of a size of a diagonal of the beam outlet 10221b of the light pipe 10221 and a magnification ratio of the lens assembly 10222 is equal to a size of a diagonal of the beam receiving surface 1024a of the DMD 1024.

As shown in FIG. 4, the optical engine 102 further includes a housing 1021. The beam adjustment assembly 1022 and the prism assembly 1023 are located in an accommodating cavity 1021 enclosed by the housing 1021, and the beam adjustment assembly 1022 and the prism assembly 1023 are both fixed to the housing 1021. It will be noted that in FIG. 3, the housing 1021 is omitted to make an internal structure of the optical engine 102 clearer. It will be understood that, FIG. 4 is a bottom view of the optical engine and the projection lens in a normal use state of the laser projection apparatus, and since the prism assembly 1023 in FIG. 4 blocks the DMD 1024, the DMD 1024 is not shown in FIG. 4.

In the optical engine 102, the DMD 1024 is a core component, which plays a role of modulating the illumination beams provided by the laser source 101 through the image signals. That is, the DMD 1024 controls the illumination beams to display different colors and luminances according to different pixels of an image to be displayed, so as to finally form an optical image. Therefore, the DMD 1024 is also referred to as an optical modulator or a light valve. Depending on whether the optical modulator (or the light valve) transmits or reflects the illumination beams, the optical modulator (or the light valve) may be classified as a transmissive optical modulator (or light valve) or a reflective optical modulator (or light valve). For example, the DMD 1024 shown in FIG. 3 reflects the illumination beams, and thus it is a reflective optical modulator. A liquid crystal light valve transmits the illumination beams, and thus it is a transmissive optical modulator. In addition, according to the number of the optical modulators (or the light valves) used in the optical engine, the optical engine may be classified as a single-chip system, a double-chip system, or a three-chip system. For example, only one DMD 1024 is used in the optical engine 102 shown in FIG. 3, and thus the optical engine 102 may be referred to as a single-chip system. In a case where three digital micromirror devices are used, the optical engine may be referred to as a three-chip system.

The digital micromirror device is applied to a digital light processing (DLP) projection architecture. The optical engine shown in FIG. 3 uses the DLP projection architecture. As shown in FIG. 5, the digital micromirror device 1024 includes thousands of micromirrors 10241 that may be individually driven to deflect. These micromirrors 10241 are arranged in an array, and each micromirror 10241 corresponds to one pixel in the image to be displayed. In the DLP projection architecture, each micromirror 10241 is equivalent to a digital switch. As shown in FIG. 6, the micromirror may swing by a range of plus or minus 12 degrees (i.e.,) ±12° or a range of plus or minus 17 degrees (i.e.,)±17° due to action of an external force. The image signals are converted into digital codes such as 0 and 1 after being processed, and these digital codes may drive the micromirrors 10241 to swing. By controlling an orientation of each micromirror 10241 in the DMD through the image signals, a luminance and a color of a pixel corresponding to the micromirror 10241 may be controlled, and a purpose of modulating the illumination beams projected onto the DMD may be achieved.

The light pipe 10221, the lens assembly 10222 and the reflector 10223 in front of the DMD 1024 form an illumination beam path. After passing through the illumination beam path, the illumination beams emitted by the laser source 101 are made to conform to an illumination size and an incident angle required by the DMD 1024.

As shown in FIG. 1, the projection lens 103 includes a combination of a plurality of lenses, which are usually divided by group, and are divided into a three-segment combination including a front group, a middle group and a rear group, or a two-segment combination including a front group and a rear group. The front group is a lens group proximate to a laser-exit side (a left side shown in FIG. 1) of the laser projection apparatus, and the rear group is a lens group proximate to a laser-exit side (a right side shown in FIG. 1) of the optical engine 102. According to the combination of the plurality of lenses, the projection lens 103 may be a zoom projection lens, or a prime adjustable-focus projection lens, or a prime projection lens. In some embodiments, the laser projection apparatus is an ultra-short-focus projection apparatus. The projection lens 103 is an ultra-short-focus projection lens, and a projection ratio of the projection lens 103 is usually less than 0.3, such as 0.24.

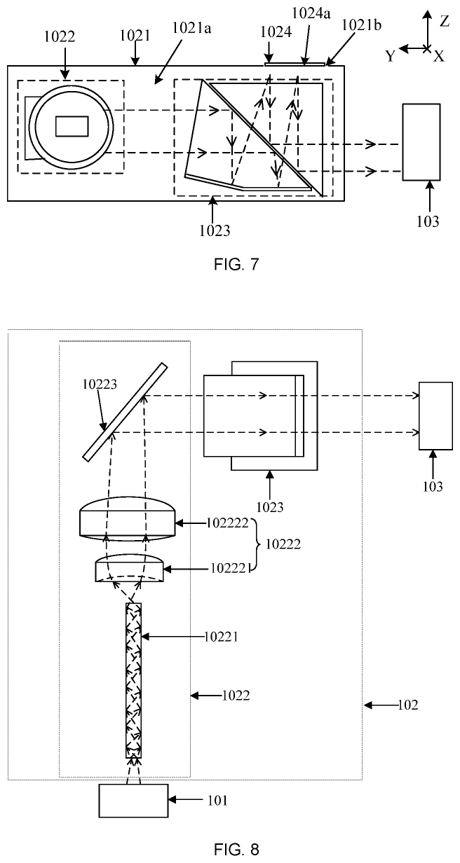

FIG. 7 is a schematic diagram showing a beam path of a laser projection apparatus, in accordance with some embodiments of the present disclosure. FIG. 8 is a top view of the beam path shown in FIG. 7. As shown in FIGS. 3, 7 and 8, the light pipe 10221, the lens assembly 10222 and the reflector 10223 are located on a bottom side of the accommodating cavity 1021a enclosed by the housing 1021 (e.g., the bottom side refers to a lower space of the accommodating cavity 1021a enclosed by the housing 1021 in a direction shown by the Z axis in FIG. 3), and geometric centers of the light pipe 10221, the lens assembly 10222, and the reflector 10223 are approximately in a same plane, and an extension direction of the light pipe 10221 is the same as an extension direction of a first optical axis of the lens assembly 10222. The DMD 1024 is located at a top side of the accommodating cavity 1021a enclosed by the housing 1021 (e.g., the top side refers to an upper space of the accommodating cavity 1021a enclosed by the housing 1021 in the direction shown by the Z axis in FIG. 3).

As shown in FIG. 7, on the top side of the accommodating cavity 1021a enclosed by the housing 1021, the DMD 1024 is disposed opposite to the prism assembly 1023, and the prism assembly 1023 is located on a side of the DMD 1024 away from the top side of the accommodating cavity 1021a. That is, in in the Z-axis direction shown in FIG. 3, the prism assembly 1023 is below the DMD 1024, and the beam receiving surface 1024a of the DMD 1024 including the plurality of micromirrors faces the prism assembly 1023.

The DMD 1024 may be located inside the accommodating cavity 1021a enclosed by the housing 1021, or may be located outside the accommodating cavity 1021a enclosed by the housing 1021.

In a case where the DMD 1024 is located outside the accommodating cavity 1021a enclosed by the housing 1021, as shown in FIG. 7, the housing 1021 further includes an accommodating cavity opening 1021b. The accommodating cavity opening 1021b may expose the beam receiving surface 1024a of the DMD 1024 to the accommodating cavity 1021a.

In some embodiments of the present disclosure, optical axes of the illumination beams in the light pipe 10221 and the lens assembly 10222 are a same optical axis. Herein, the optical axis is referred to as a first optical axis I-I. In some embodiments, the first optical axis passes through the geometric centers of the light pipe 10221 and the lens assembly 10222. Illumination beams exiting from the lens assembly 10222 are projected onto the beam receiving surface 1024a of the DMD 1024 after sequentially skimming over the reflector 10223 and passing through the prism assembly 1023, and then are reflected by the beam receiving surface 1024a of the DMD 1024 again to the prism assembly 1023. Herein, an optical axis of the illumination beams reflected by the reflector 10233 to the prism assembly 1023 is referred to as a second optical axis II-II, and an optical axis of projection beams reflected by the beam receiving surface 1024a of the DMD 1024 again to the prism assembly 1023 (in this case, the illumination beams are modulated by the DMD 1024 into projection beams) is referred to as a third optical axis III-III. Thereafter, the prism assembly 1023 reflects the received projection beams reflected by the beam receiving surface 1024a of the DMD 1024 to the projection lens 103. Herein, an optical axis of the projection beams reflected by the prism assembly 1023 to the projection lens 103 is referred to as a fourth optical axis IV-IV. In some embodiments, the fourth optical axis passes through a geometric center of the projection lens 103. The first optical axis I-I of the lens assembly 10222 and the fourth optical axis IV-IV of the projection lens 103 are perpendicular but do not intersect (in some embodiments, they may also be perpendicular and intersect), and the beam receiving surface 1024a of the DMD 1024 faces a plane parallel to both the optical axis I-I and the fourth optical axis IV-IV. The first optical axis I-I and the second optical axis II-II are perpendicular, and the first optical axis I-I and the second optical axis II-II are both parallel to the beam receiving surface 1024a of the digital micromirror device 1024.

As shown in FIGS. 7 and 8, after the illumination beams from the laser source 101 enter the optical engine 102, the illumination beams first enter the light pipe 10221 in the beam adjustment assembly 1022, and are homogenized by the light pipe 10221, and then are amplified first and converged next by the lens assembly 10222 to have an illumination size required by the beam receiving surface 1024a of the DMD 1024. Afterwards, the illumination beams irradiate the reflector 10223, and are reflected by the reflector 10223 to the prism assembly 1023. The illumination beams entering the prism assembly 1023 are first reflected by the prism assembly 1023 to the beam receiving surface 1024a of the DMD 1024, and then modulated by the beam receiving surface 1024a into the projection beams corresponding to the image signals and the projection beams are reflected to the prism assembly 1023. Then, the projection beams are reflected by the prism assembly 1023 to the projection lens 103, and finally projected by the projection lens 103 for imaging.

A vertical axis of the beam receiving surface 1024a of the digital micromirror device 1024 and an optical axis of a beam incident surface of the projection lens 103 are perpendicular to each other.

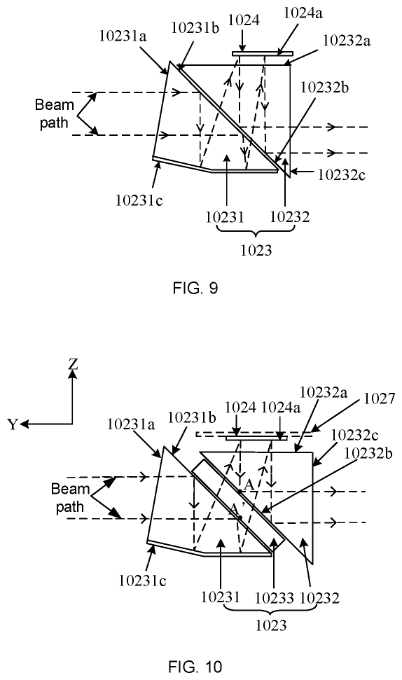

FIG. 9 is a schematic diagram showing a beam path in a prism assembly of a laser projection apparatus, in accordance with some embodiments of the present disclosure. In some embodiments, referring to FIG. 9, the prism assembly 1023 includes a first prism 10231 and a second prism 10232.

Referring to FIG. 9, the first prism 10231 is configured to receive the illumination beams reflected by the reflector 10223, and reflect the received illumination beams to the beam receiving surface 1024a of the DMD 1024. In this process, the illumination beams exiting from the first prism 10231 may pass through the second prism 10232 and then be projected onto the beam receiving surface 1024a of the DMD 1024, so that the beam receiving surface 1024a of the DMD 1024 modulates the illumination beams into the projection beams corresponding to the image signals of the image to be displayed. The second prism 10232 is configured to receive the projection beams reflected by the beam receiving surface 1024a, and reflect the projection beams to the projection lens 103. An optical axis of the illumination beams entering the first prism 10231 is parallel to an optical axis of the projection beams reflected by the second prism 10232 to the projection lens 103.

It will be noted that, in FIG. 9, for convenience of showing the beam path in the prism assembly 1023 of the laser projection apparatus, the light pipe 10221, the lens assembly 10222, the reflector 10223 and the projection lens 103 are not shown in FIG. 9.

In some embodiments, as shown in FIG. 9, the first prism 10231 includes a first incident surface 10231a, a first exit surface 10231b, and a first reflection surface 10231c. The first incident surface 10231a is configured to receive the illumination beams from the reflector 10223. The first exit surface 10231b is configured to reflect the illumination beams received by the first incident surface 10231a to the first reflection surface 10231c, and transmit the illumination beams reflected by the first reflection surface 10231c to the beam receiving surface 1024a of the DMD 1024. The first reflection surface 10231c is configured to reflect the received illumination beams reflected by the first exit surface 10231b again to the first exit surface 10231b. The illumination beams are then transmitted to the beam receiving surface 1024a of the DMD 1024 through the first exit surface 10231b.

In some embodiments, as shown in FIG. 9, the second prism 10232 includes a second incident surface 10232a, a second reflection surface 10232b, and a second exit surface 10232c. The second incident surface 10232a is configured to receive the projection beams which are obtained after the modulation by the beam receiving surface 1024a of the DMD 1024. The second reflection surface 10232c is configured to reflect the projection beams received by the second incident surface 10232a to the second exit surface 10232b. The second exit surface 10232b is configured to transmit the projection beams reflected by the second reflection surface 10232c to the projection lens. In some embodiments, the second incident surface 10232a, the second reflection surface 10232b, and the second exit surface 10232c may all be flat surfaces.

The first exit surface 10231b of the first prism 10231 is adjacent to and opposite to the second reflection surface 10232b of the second prism 10232, and there is a gap between the first exit surface 10231b and the second reflection surface 10232b of the second prism 10232.

As shown in FIG. 9, the illumination beams provided by the laser source 101 enter the first prism 10231 through the first incident surface 10231a of the first prism 10231, and then are reflected by the first exit surface 10231b of the first prism 10231 to the first reflection surface 10231c of the first prism 10231, and finally are reflected by the first reflection surface 10231c and exit from the first prism 10231 through the first exit surface 10231b.

In some embodiments, the first incident surface 10231a, the first exit surface 10231b, and the first reflection surface 10231c may all be flat surfaces. For example, the first prism 10231 may be a triangular prism with flat side surfaces.

In some embodiments, as shown in FIG. 9, the first incident surface 10231a and the first exit surface 10231b may both be flat surfaces, and the first reflection surface 10231c may be a curved surface. That is, the first prism 10231 may be a triangular prism with a curved side surface. In this case, the first reflection surface 10231c is also configured to shape the received illumination beams reflected by the first exit surface 10231b. That is, the illumination beams are made to form a beam spot with uniformly distributed energy, so that a shaping lens configured to shape the illumination beams that is between the laser source 101 and the prism assembly 1023 may be omitted. Therefore, the number of optical components (e.g., the shaping lens) in the laser projection apparatus may be reduced, a volume of the laser projection apparatus may be reduced, and space occupied by the laser projection apparatus may be reduced.

In some embodiments, in a case where the the first reflection surface 10231c of the first prism 10231 is a curved surface, the first reflection surface 10231c may be a spherical reflection surface or an aspherical reflection surface. The embodiments of the present disclosure do not limit a structure of the curved surface of the first reflection surface 10231c, as long as it is ensured that the curved reflection surface 10231c reflects the illumination beams entering the first prism 10231 to the beam receiving surface 1024a of the DMD 1024.

As shown in FIG. 9, the illumination beams exiting from the first prism 10231 pass through the second reflection surface 10232b of the second prism 10232 to enter the second prism 10232, and are projected onto the beam receiving surface 1024a of the DMD 1024 after exiting from the second incident surface 10232a of the second prism 10232. The illumination beams are modulated by the beam receiving surface 1024a of the DMD 1024 into the projection beams corresponding to the image signals and then the projection beams are reflected. The projection beams pass through the second incident surface 10232a again along a reflected beam path to enter the second prism 10232, and are then reflected by the second reflection surface 10232b of the second prism 10232, and pass through the second exit surface 10232c of the second prism 10232 to exit from the second prism 10232, and finally enter the projection lens 103.

It will be noted that, since the illumination beams are able to pass through the first exit surface 10231b of the first prism 10231 and exit, the first exit surface 10231b is able to transmit light. Moreover, since the first exit surface 10231b may also reflect the illumination beams, this reflection of the illumination beams on the first exit surface 10231b is a total reflection. Similarly, since the illumination beams are able to pass through the the second reflection surface 10232b of the second prism 10232 and enter the second prism 10232, the second reflection surface 10232b is able to transmit light. Moreover, since the second reflection surface 10232b may also reflect the projection beams, this reflection of the projection beams on the second reflection surface 10232b is a total reflection.

In order to ensure that the total reflection may occur on both the first exit surface 10231b and the second reflection surface 10232b, the following conditions must be satisfied: first, a refractive index of a medium in contact with the first exit surface 10231b of the first prism 10231 must be smaller than a refractive index of the first prism 10231; and second, a refractive index of a medium in contact with the second reflection surface 10232b of the second prism 10232 must be smaller than a refractive index of the second prism 10232. However, in a case where the first prism 10231 is in contact with the second prism 10232, that is, the first exit surface 10231b is in contact with the second reflection surface 10232b, the two conditions cannot be satisfied simultaneously. Therefore, there is a gap (e.g., air) between the second prism 10232 and the first prism 10231, and a refractive index of the gap is less than the refractive index of the first prism and less than the refractive index of the second prism.

When the laser projection apparatus works normally, the laser projection apparatus is usually placed in a way that the fourth optical axis of the projection lens 103 is parallel to a horizontal plane, and the fourth optical axis of the projection lens 103 is perpendicular or approximately perpendicular to a vertical direction. In this case, in the vertical direction, the optical axis of the illumination beams entering the first prism 10231 is referred to as the second optical axis, and the optical axis of the projection beams entering the projection lens 103 after being reflected by the second prism 10232 is referred to as the fourth optical axes. The second optical axis is parallel or approximately parallel to the fourth optical axis. The smaller a distance between the second optical axis and the fourth optical axis is, the smaller a size of the laser projection apparatus in the vertical direction is.

In order to further reduce the size of the laser projection apparatus in the vertical direction, the distance between the second optical axis and the fourth optical axis in the vertical direction may be further reduced to make the distance close to zero. That is, the second optical axis is close to or coincides with the fourth optical axis.

For this purpose, in some embodiments, referring to FIG. 10, the prism assembly 1023 further includes a third prism 10233. The third prism 10233 is configured to adjust a beam path distance of the illumination beams in the prism assembly 1023, and reduce the size of the laser projection apparatus in the vertical direction, which will be further explained later.

The third prism 10233 is located between the first prism 10231 and the second prism 10232. For example, as shown in FIG. 10, the third prism 10233 is located between the first exit surface 10231b of the first prism 10231 and the second reflection surface 10232b of the second prism 10232.

In a case where the third prism 10233 is provided, in order to ensure that the illumination beams may still be projected onto the beam receiving surface 1024a of the DMD 1024, there is a need to ensure that a position where the illumination beams are projected onto the beam receiving surface 1024a is not changed. In this case, there is a need to ensure that a critical angle is not changed when a total reflection of the illumination beams in the first prism 10231 occurs on the first exit surface 10231b (i.e., a surface close to the third prism 10233); the critical angle θ satisfying: θ=arcsin(n2/n1) where n1 is a refractive index of an optical dense medium, and n2 is a refractive index of an optical thinner medium. That is to say, regardless of whether or not the third prism is provided, the critical angle is unchanged when the total reflection occurs on the first exit surface 10231b. And there is a need to ensure that a critical angle is not changed when a total reflection of the projection beams occurs on the second reflection surface 10232b of the second prism 10232 (i.e., a surface close to the third prism 10233). That is to say, regardless of whether or not the third prism is provided, the critical angle is unchanged when the total reflection occurs on the second reflection surface 10232b.

For the above reasons, this requires that the refractive index of the medium in contact with the first exit surface 10231b remains unchanged, and the refractive index of the medium in contact with the second reflection surface 10232b remains unchanged. Therefore, in the case where the third prism 10233 is provided, there is a need to ensure that the third prism 10233 is in contact with neither the first prism 10231 nor the second prism 10232. That is to say, there is a gap between the third prism 10233 and the first exit surface 10231b of the first prism 10231, and there is also a gap between the third prism 10233 and the second reflection surface 10232c of the second prism 10232. The gap may be, for example, air.

In some embodiments, as shown in FIG. 10, a surface of the third prism 10233 facing the first prism 10231 is parallel to a surface of the third prism 10233 facing the second prism 10232. The third prism 10233 may be, for example, a flat prism.

With continued reference to FIG. 10, the illumination beams exiting from the first prism 10231 are projected onto the beam receiving surface 1024a of the DMD 1024 after sequentially passing through the third prism 10233 and the second prism 10232. Since the beam path distance of the prism assembly 1023 is increased due to the third prism 10233, a position where the projection beams are reflected by the second reflection surface 10232b of the second prism 10232 may be shifted upward in the vertical direction. For example, in FIG. 10, the reflection position is shifted up from A′ in a case where the third prism 10233 is not provided to A. The larger a thickness of the third prism 10233 is, the larger a displacement of the upward shift of the position where the projection beams are reflected by the second reflection surface 10232b in the vertical direction is. Therefore, by providing the third prism 10233, it may be possible to appropriately adjust a distance between the optical axis of the projection beams exiting from the prism assembly 1023 (i.e., the fourth optical axis IV-IV of the projection beams reflected by the prism assembly 1023 to the projection lens 103) and the second optical axis II-II, so that the distance between the fourth optical axis IV-IV and the second optical axis II-II is close to zero. In this case, the optical axis of the projection beams exiting from the prism assembly 1023 is designed to coincide with or close to the second optical axis II-II, so that the distance between the second optical axis II-II and the fourth optical axis IV-IV is the smallest in the vertical direction, thereby further reducing the size of the laser projection apparatus in the vertical direction.

It will be noted that, in the case where the third prism 10233 is provided, beam paths in the first prism 10231 and the second prism 10232 are the same as beam paths in the first prism 10231 and the second prism 10232 in the prism assembly 1023 shown in FIG. 9, and reference may be made to the corresponding description of the beam paths in the first prism 10231 and the second prism 10232 in the prism assembly shown in FIG. 9 described above, which will not be repeated herein.

It will be noted that, in FIG. 10, for convenience of showing the beam path in the prism assembly 1023 of the laser projection apparatus, the light pipe 10221, the lens assembly 10222, the reflector 10223 and the projection lens 103 are not shown in FIG. 10.

In some embodiments, since the DMD 1024 is typically disposed on a circuit board 1027 (shown by the dashed line in FIG. 10), and as shown in FIG. 10, in the vertical direction (i.e., an extension direction of the Z axis), a connection position between the first incident surface 10231a and the first exit surface 10231b of the first prism 10231 may be higher than the second prism 10232, the first prism 10231 may easily interfere in position-wise with the circuit board 1027. By providing the third prism 10233 between the first exit surface 10231b of the first prism 10231 and the second reflection surface 10232b of the second prism 10232, a horizontal distance between the first prism 10231 and the circuit board 1027 (i.e., a distance in an extension direction of a Y axis) may be increased, so as to prevent the first prism 10231 from interacting with the circuit board 1027.

Since the reflector 10223 directly reflects the illumination beams to the first prism 10231 in the prism assembly 1023, a height of the reflector 10223 in the vertical direction may be regarded as a height of the second optical axis II-II in the vertical direction. Since the geometric centers of the light pipe 10221, the lens assembly 10222, and the reflector 10223 in the beam adjustment assembly 1022 are approximately in a same plane, a height of the beam adjustment assembly 1022 in the vertical direction may also be approximately regarded as a height of the first optical axis I-I in the vertical direction. In this case, ensuring that the distance between the second optical axis II-II and the fourth optical axis IV-IV in the vertical direction is as small as possible enables the beam adjustment assembly 1022, the prism assembly 1023 and the projection lens 103 to be approximately in a same plane, thereby making a layout of the laser projection apparatus more compact, and reducing the space occupied by the laser projection apparatus.

In some embodiments of the present disclosure, the second optical axis II-II of the illumination beams incident on the first incident surface 10231a of the first prism 10231 is not parallel to the fourth optical axis IV-IV of the projection beams exiting from the second exit surface 10232c of the second prism 10232; instead, there is an included angle therebetween, and a magnitude of the included angle is in a range of 0° to 20°, inclusive. In a case where the included angle is 0°, the second optical axis II-II is parallel to or coincides with the fourth optical axis IV-IV.

For example, the included angle between the second optical axis II-II of the illumination beams incident on the first incident surface 10231a of the first prism 10231 and the fourth optical axis IV-IV of the projection beams exiting from the second exit surface 10232c of the second prism 10232 may be 0°, 10°, or 20°. In a case where the included angle is equal to 0°, the illumination beams incident on the first incident surface 10231a of the first prism 10231 may be parallel to or coincide with the projection beams exiting from the second exit surface 10232c of the second prism 10232.

It will be noted that, the illumination beams incident on the first incident surface 10231a of the first prism 10231 may be a plurality of parallel illumination beams. For example, the illumination beams incident on the first incident surface 10231a of the first prism 10231 shown in FIGS. 9 and 10 are two parallel illumination beams. Of course, it can be understood that, the plurality of illumination beams incident on the first incident surface 10231a of the first prism 10231 may also be non-parallel. That is, there may also be an included angle between at least two of the plurality of illumination beams incident on the first incident surface 10231a of the first prism 10231.

In some embodiments, the third prism 10233 may be fixedly connected to the first prism 10231 through an adhesive dispensing method, and the third prism 10233 may be fixedly connected to the second prism 10232 through an adhesive dispensing method. For example, the gap between the third prism 10233 and the first prism 10231 is filled with an adhesive, and the gap between the third prism 10233 and the second prism 10232 is filled with an adhesive. The first prism 10231 and the third prism 10233 are fixedly connected through the adhesive, and the second prism 10232 and the third prism 10233 are fixedly connected through the adhesive.

In a case where the first prism 10231 and the third prism 10233 are fixedly connected through the adhesive dispensing method, and the second prism 10232 and the third prism 10233 are fixedly connected through the adhesive dispensing method, since the adhesive is easy to melt at a high temperature, the positions of the first prism 10231, the second prism 10232, and the third prism 10233 are easily changed. Especially in a case where the position of the second prism 10232 is changed, it is difficult for the beams to accurately enter the projection lens 103 after passing through the prism assembly 1023.

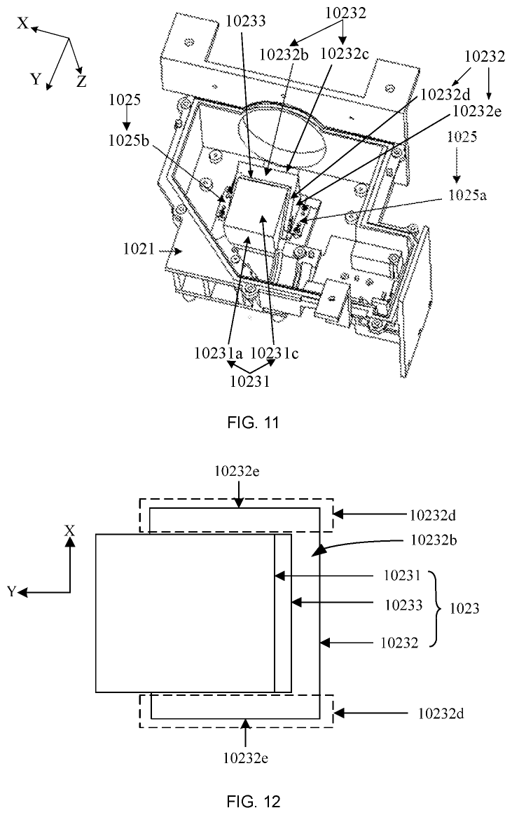

In order to reduce influence of the melting of the adhesive which is used in the adhesive dispensing method on a projection process, referring to FIGS. 11 and 12, in some embodiments, the optical engine 102 further includes at least one prism fixing member 1025.

FIG. 11 is a schematic diagram showing a partial structure of a laser projection apparatus, in accordance with some embodiments of the present disclosure, and FIG. 12 is a bottom view of a prism assembly in a laser projection apparatus, in accordance with some embodiments of the present disclosure. However, it will be understood that, FIG. 11 is a schematic diagram showing the partial structure of the laser projection apparatus when viewed from bottom to top in a normal use state.

Referring to FIG. 12, the second prism 10232 includes prism fixing portions 10232d. For example, FIG. 12 shows two prism fixing portions 10232d extending in directions of normal lines of non-acting surfaces 10232e for the beams of the second prism 10232. In the second prism 10232, the non-acting surfaces 10232e are connected to all of the second incident surface 10232a, the second reflection surface 10232b, and the second exit surface 10232c. The beams do not reach the non-acting surfaces 10232e, and thus the non-acting surfaces 10232e do not reflect or transmit the beams.

In some embodiments, the prism fixing portions 10232d are portions of the second prism 10232, and are integrally formed with the second prism 10232. Referring to FIG. 12, in a direction (i.e., an extension direction of an X axis) perpendicular to an extension direction of the fourth optical axis IV-IV of the projection lens 103 (i.e., the extension direction of the Y axis), a length of a surface of the second prism 10232 facing the third prism 10233 (i.e., the second reflection surface 10232b) is greater than a length of a surface of the first prism 10231 facing the third prism 10233 (i.e., the first exit surface 10231b), and the length herein refers to a dimension in the extension direction of the X axis in FIG. 12. Thus, a portion of the second prism 10232 that exceeds the first prism 10231 in the extension direction of the X axis forms a prism fixing portion 10232d. Two prism fixing portions 10232d are shown in FIG. 12, and each prism fixing portion 10232d corresponds to a prism fixing member 1025 to fix the second prism 10232 on the housing 1021. As shown in FIG. 11, in some embodiments, the second prism 10232 is fixed on an inner wall of the top side of the housing 1021.

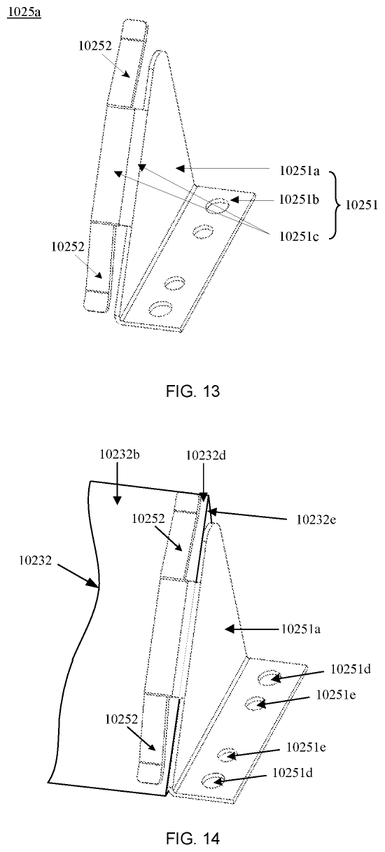

In an example in which the second prism 10232 is a triangular prism, FIG. 13 is a schematic diagram showing a structure of a prism fixing member, in accordance with some embodiments of the present disclosure, and FIG. 14 is a schematic diagram showing an assembly structure of the prism fixing member shown in FIG. 13 and the second prism.

In some embodiments, the at least one prism fixing member 1025 includes a first prism fixing member 1025a. Referring to FIG. 13, the first prism fixing member 1025a includes a bracket 10251 and first elastic sheets 10252. The first prism fixing member 1025a shown in FIG. 13 includes two first elastic sheets 10252.

The bracket 10251 includes a baffle plate 10251a, a bracket fixing portion 10251b, and a connecting portion 10251c. The baffle plate 10251a is connected to the bracket fixing portion 10251b and the connecting portion 10251c. The baffle plate 10251a is an approximately triangular sheet. The connecting portion 10251c is connected to a side of the baffle plate 10251a, and a length of the connecting portion 10251c is less than a length of the side; and the connecting portion 10251c is also connected to the two first elastic sheets 10252, which are located on both sides of the connecting portion 10251c respectively, and are adjacent to but not connected to the baffle plate 10251a. The bracket fixing portion 10251b is connected to another side of the baffle plate 10251a. The bracket fixing portion 10251b is configured to be fixedly connected to the housing 1021, so as to fix the first prism fixing member 1025a to the housing 1021.

Referring to FIG. 14, the bracket fixing portion 10251b includes fixing holes 10251d. The first prism fixing member 1025a may be fixed to the housing 1021 by installing corresponding fixing members (e.g., screws) in the fixing holes 10251d. In addition, the bracket fixing portion 10251b further includes positioning holes 10251e. An installation position of the first prism fixing member 1025a may be defined through cooperation between the positioning holes 10251e and positioning posts on the housing 1021.

Referring to FIGS. 12 and 14, each first elastic sheet 10252 abuts against a prism fixing portion 10232d to press the second prism 10232 on the housing 1021, so as to fix the second prism 10232 to the housing 1021 in a direction parallel to the third optical axis III-III of the DMD 1024 (i.e., the extension direction of the Z axis in FIG. 11). In addition, the two first elastic sheets 10252 may also press the second prism 10232 on a device located on a side of the second exit surface 10232c of the second prism 10232, so as to fix the second prism 10232 to the device and in turn to the housing 1021 in the extension direction of the fourth optical axis IV-IV of the projection lens 103 (i.e., the extension direction of the Y axis in FIG. 11).

The second prism 10232 includes two non-acting surfaces 10232e, and the baffle plate 10251a is configured to abut against one non-acting surface 10232e of the second prism 10232, so as to fix the position of the second prism 10232 in the extension direction of the first optical axis I-I of the lens assembly 10222 (i.e., the extension direction of the X axis in FIG. 11), so that the second prism 10232 is fixed relative to the housing 1021.

It can be seen therefrom that, the first prism fixing member 1025a is able to fix the second prism 10232 to the housing 1021 in the extension directions of the X axis, the Y axis, and the Z axis.

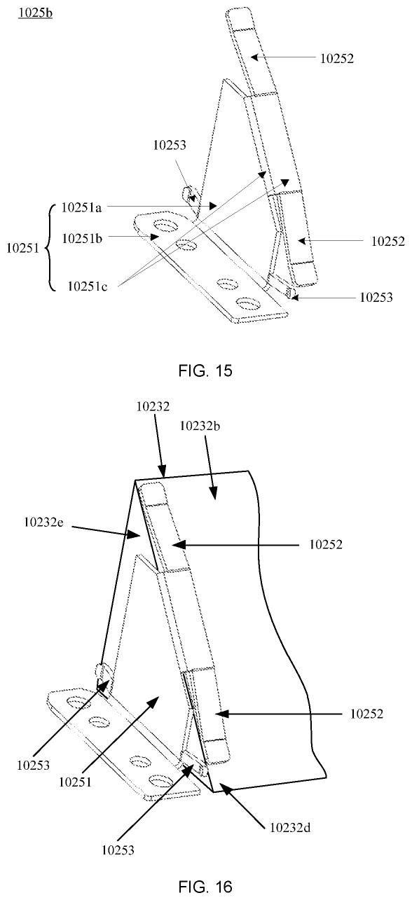

In some embodiments, the at least one prism fixing member further includes a second prism fixing member 1025b. Referring to FIG. 15, the second prism fixing member 1025b includes a bracket 10251, first elastic sheets 10252, and second elastic sheets 10253. The second prism fixing member 1025b shown in FIG. 15 includes two first elastic sheets 10252 and two second elastic sheets 10253. The bracket 10251 includes a baffle plate 10251a, a bracket fixing portion 10251b, and a connecting portion 10251c.

Referring to FIG. 15, the baffle plate 10251a is an approximately quadrangular or pentagonal sheet. The connecting portion 10251c is connected with a side of the baffle plate 10251a; and the connecting portion 10251c is also connected with the two first elastic sheets 10252. The bracket fixing portion 10251b is connected to another side of the baffle plate 10251a; and the bracket fixing portion 10251b is configured to be fixedly connected to the housing 1021, so as to fix the second prism fixing member 1025b to the housing 1021. The two second elastic sheets 10253 are connected to another two opposite sides of the baffle plate 10251a. As shown in FIG. 16, the two second elastic sheets 10253 are configured to abut against the non-acting surfaces 10232e of the second prism 10232, so as to increase reliability of fixing the second prism 10232 through the second prism fixing member 1025b.

The baffle plate 10251a, the bracket fixing portion 10251b, the connecting portion 10251c, and the two first elastic sheets 10252 shown in FIG. 16 are used in a same manner as that shown in FIG. 14, and details will not be repeated herein.

By providing at least one prism fixing member 1025, the second prism 10232 may be fixed to the housing 1021. Although the adhesive is easy to melt at a high temperature, a fixing function of the at least one prism fixing member 1025 makes it difficult to change relative positions of the second prism 10232 and the housing 1021, thereby making it difficult to change the position of the second prism 10232 in the accommodating cavity 1021a, and effectively ensuring that the beams enter the projection lens 103 after passing through the prism assembly 1023.

In addition, in some embodiments of the present disclosure, in a case where only the second prism 10232 is fixed to the housing 1021, and the first prism 10231 or the third prism 10233 is not fixed to the housing 1021, the position of the first prism 10231 (or the third prism 10233) itself may be changed as the adhesive melts at a high temperature, so that the first prism 10231 (and the third prism 10233) has a certain degree of freedom of movement. If the first prism 10231 (and the third prism 10233) is also fixed to the housing 1021, the movement of the first prism 10231 (and the third prism 10233) is inhibited, which easily causes damage to the first prism 10231 (and the third prism 10233).

In some embodiments, the at least one prism fixing member in the laser projection apparatus may each be a first prism fixing member 1025a, or may each be a second prism fixing member 1025b, or may also include at least one first prism fixing member 1025a and at least one second prism fixing member 1025b, etc., which is not limited in the embodiments of the present disclosure.

In some embodiments, the first prism fixing member 1025a and the second prism fixing member 1025b may be made of stainless steel.

It can be understood that, the first prism fixing member 1025a and the second prism fixing member 1025b may also be made of materials other than the stainless steel, such as plastic or metal, which are not limited in the embodiments of the present disclosure.

The DMD 1024 is prone to generate heat during operation. In order to dissipate heat of the DMD 1024, in some embodiments, the laser projection apparatus may further include a cooling component 1029.

In some embodiments, based on the way that the laser projection apparatus is placed when it works normally (referring to the above description, which will not be repeated herein), since a surface of the DMD 1024 facing away from the beam receiving surface 1024a is perpendicular to the vertical direction, the cooling component 1029 may be disposed on a side of the DMD 1024 away from the beam receiving surface 1024a in the vertical direction. That is to say, as shown in FIG. 2, taking a direction away from the ground as an upper direction, and taking a direction close to the ground as a lower direction, the cooling component 1029 is disposed above the DMD 1024. In this case, although the cooling component 1029 has a certain weight in the vertical direction, the DMD 1024 and the housing 1021 can have a bearing effect on the cooling component 1029 in the vertical direction, so that the cooling component 1029 is not easy to shift or fall off due to its own weight, and is reliably fixed.

In some embodiments, the DMD 1024 adopts a liquid-cooling method to dissipate heat. The cooling component 1029 may be a flat-plate liquid-cooling radiator (which may also be referred to as a cooling head) with a small volume, so that space occupied by the optical engine 102 may be effectively reduced, and the volume of the laser projection apparatus may be reduced. In addition, a cooling component 1029 of the DMD 1024 and a cooling component of the laser source 101 may also be connected in series. That is, the cooling component 1029 of the DMD 1024 and the cooling component of the laser source 101 may be a commonly-used cooling component, so as to further reduce space occupied by the cooling component, the space occupied by the optical engine 102, and the volume of the laser projection apparatus.

The cooling component 1029 in the laser projection apparatus is in contact with the DMD 1024 to exchange heat with the DMD 1024 to dissipate the heat of the DMD 1024. Since the cooling component 1029 is heavier than the DMD 1024, in this case, when the laser projection apparatus shakes, the cooling component 1029 also shakes; a position of the DMD 1024 is easy to shift when the DMD 1024 is subjected to an acting force from the cooling component 1029; and in severe cases, the projection beams may not be formed or the projection beams cannot enter the projection lens, which causes the laser projection apparatus to fail to project an image normally.

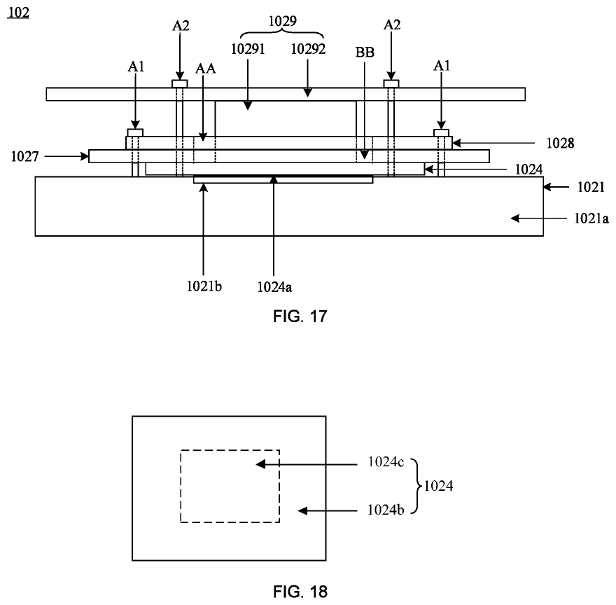

Based on the above existing problem, some embodiments of the present disclosure provide a laser projection apparatus. FIG. 17 is a schematic diagram showing a structure of an optical engine in a laser projection apparatus, in accordance with some embodiments of the present disclosure. Referring to FIGS. 2 and 17, the optical engine 102 further includes the circuit board 1027, a fixing plate 1028, the cooling component 1029, a plurality of first screws A1, and a plurality of second screws A2.

As shown in FIG. 17, the housing 1021 includes an accommodating cavity opening 1021b corresponding to the DMD 1024. The DMD 1024 is disposed outside the accommodating cavity 1021a enclosed by the housing 1021 corresponding to a position of the accommodating cavity opening 1021b. The beam receiving surface 1024a of the DMD 1024 faces the accommodating cavity 1021a and is exposed in the accommodating cavity 1021a. Herein, the surface of the DMD 1024 facing away from the beam receiving surface 1024a is referred to as a heat dissipation surface. The heat dissipation surface is configured to be in contact with the cooling component 1029 to perform heat conduction with the cooling component 1029.

As shown in FIG. 17, the circuit board 1027 is in contact with part of the heat dissipation surface of the DMD 1024, and the fixing plate 1028 is in contact with a surface of the circuit board 1027 facing away from the DMD 1024; the fixing plate 1028 includes a first opening AA, the circuit board 1027 includes a second opening BB, and the DMD 1024 is exposed to the cooling component 1029 through the first opening AA and the second opening BB; and the circuit board 1027 and the fixing plate 1028 are fixed to the housing 1021 through the plurality of first screws A1.

The cooling component 1029 includes a cooling terminal 10291 and a fixing terminal 10292 connected to the cooling terminal 10291. The cooling terminal 10291 sequentially passes through the first opening AA and the second opening BB to contact the heat dissipation surface of the DMD 1024, and the cooling terminal 10291 is configured to perform heat conduction with the heat dissipation surface. The fixing terminal 10292 is fixed to the housing 1021 through the plurality of second screws A2.

FIG. 18 is a schematic diagram showing a structure of the heat dissipation surface of the digital micromirror device, in accordance with some embodiments of the present disclosure. In some embodiments, as shown in FIG. 18, the heat dissipation surface of the DMD 1024 includes a bearing region 1024b and a heat dissipation region 1024c. The bearing region 1024b is configured to be in contact with the circuit board 1027. The heat dissipation region 1024c is configured to be in contact with the cooling terminal 10291.

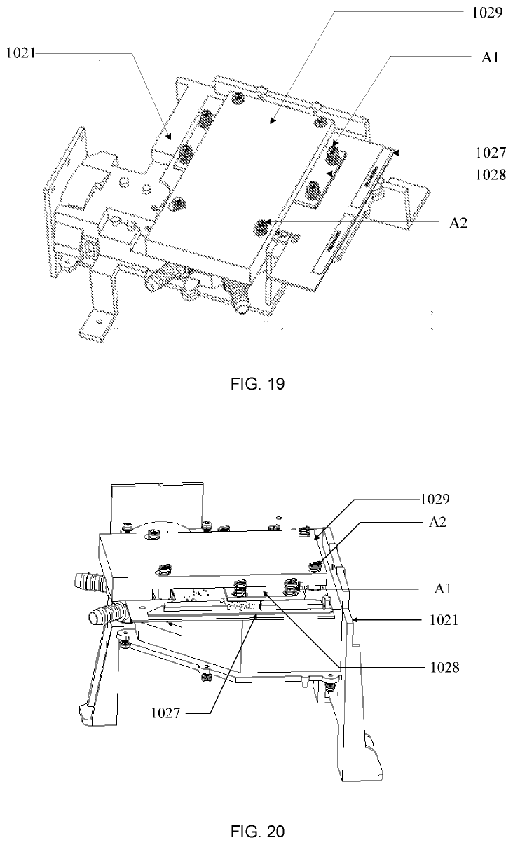

FIG. 19 is a schematic diagram showing a structure of the optical engine shown in FIG. 17 from one angle; and FIG. 20 is a schematic diagram showing a structure of the optical engine shown in FIG. 17 from another angle. As shown in FIGS. 17, 19 and 20, the fixing terminal 10292 in the cooling component 1029 is fixed to the housing 1021 through the plurality of (e.g., four) second screws A2, so as to fix the cooling component 1029 to the housing 1021. The circuit board 1027 and the fixing plate 1028 press the DMD 1024 on the housing 1021. The circuit board 1027 and the fixing plate 1028 are fixed to the housing 1021 through the plurality of (e.g., four) first screws A1, so as to achieve a purpose of fixing the DMD 1024 to the housing 1021. It will be noted that, due to blocking of the cooling component 1029, the DMD 1024 is not shown in FIGS. 19 and 20.

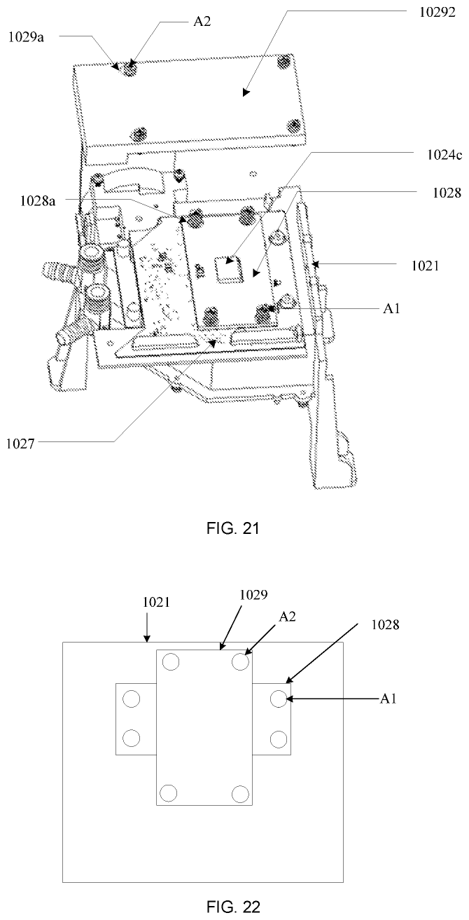

FIG. 21 is a schematic diagram showing a structure in which the cooling component is separated from the optical engine shown in FIG. 19 or 20. In some embodiments, as shown in FIGS. 19, 20 and 21, the fixing plate 1028 may include a plurality of fixing plate through holes 1028a, for example, the fixing plate 1028 shown in FIG. 21 includes four fixing plate through holes 1028a; and the circuit board 1027 may include a plurality of circuit board through holes (not shown in FIG. 21 due to blocking of the fixing plate 1028). Each first screw A1 may sequentially pass through a fixing plate through hole 1028a and a circuit board through hole, and is screwed with the housing 1021, so as to fix the fixing plate 1028, the circuit board 1027 and the DMD 1024 to the housing 1021. The heat dissipation region 1024c of the heat dissipation surface of the DMD 1024 is exposed to the cooling component 1029 through the first opening AA of the fixing plate 1028 and the second opening BB of the circuit board 1027.

As shown in FIGS. 19, 20 and 21, the fixing terminal 10292 includes a plurality of fixing terminal through holes 1029a, for example, the fixing terminal 10292 shown in FIG. 21 includes four fixing terminal through holes 1029a; and each second screw A2 may pass through a fixing terminal through hole 1029a to be screwed with the housing 1021, so as to fix the cooling component 1029 to the housing 1021. The cooling terminal 10291 of the cooling component 1029 sequentially passes through the first opening AA of the fixing plate 1028 and the second opening BB of the circuit board 1027 to contact the heat dissipation region 1024c of the DMD 1024.

It can be understood that, the number of the plurality of first screws A1 may be four, or less than four (e.g., two or three) or more than four (e.g., five or six), as long as it is ensured that the fixing plate 1028 and the circuit board 1027 are fixed to the housing 1021 through the plurality of first screws A1. The number of the plurality of first screws A1 is not limited in the embodiments of the present disclosure. Similarly, the number of the plurality of second screws A2 may also be less than four (e.g., two or three) or more than four (e.g., five or six), as long as it is ensured that the cooling component 1029 is fixed to the housing 1021 through the plurality of second screws A2. The number of the plurality of second screws A2 is not limited in the embodiments of the present disclosure.

FIG. 22 is a top view of the optical engine shown in FIG. 17. In some embodiments, referring to FIG. 22, an orthogonal projection of the cooling component 1029 on the housing 1021 and orthogonal projections of the plurality of first screws A1 on the housing 1021 do not overlap. In this case, on one hand, it may be possible to avoid that the fixing plate 1028 is difficult to disassemble and install due to that the cooling component 1029 blocks the plurality of first screws A1, which otherwise brings inconvenience to maintenance of the laser projection apparatus; and on another hand, it may also be possible to prevent the cooling component 1029 from being damaged due to that the cooling component 1029 is otherwise easy to collide with the plurality of first screws A1 when it shakes. It will be noted that, for ease of illustration, FIG. 22 only exemplarily shows a case where the number of the plurality of first screws A1 is four.

With continued reference to FIG. 22, in some embodiments, orthogonal projections of the plurality of second screws A2 on the housing 1021 and an orthographic projection of the fixing plate 1028 on the housing 1021 do not overlap, so that the cooling component 1029 may be separately fixed on the housing 1021 through the plurality of second screws A2.

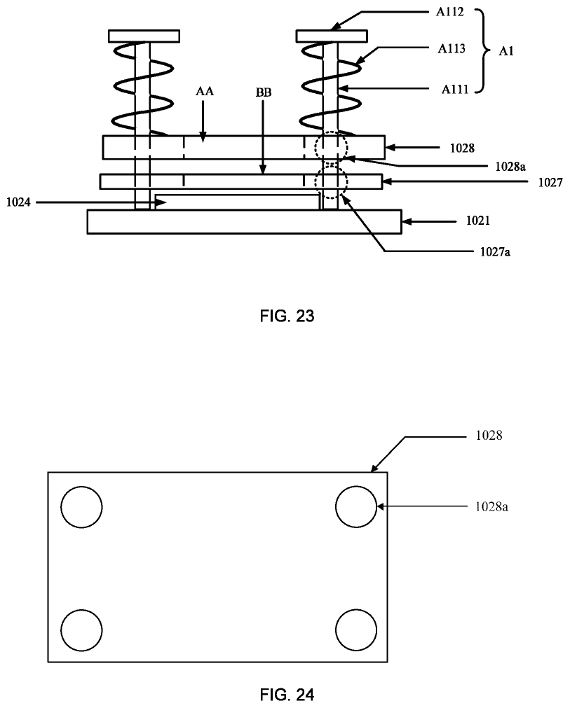

FIG. 23 is a schematic diagram showing a structure of a first screw in the optical engine shown in FIG. 17.

Referring to FIG. 23, each first screw A1 includes a first screw stem A111, a first screw head A112 at an end of the first screw stem A111, and a first spring A113 sleeved on the first screw stem A111. One end of the first spring A113 abuts against the first screw head A112, and the other end thereof abuts against the fixing plate 1028. In this case, a depth to which the first screw stem A111 of the first screw A1 is rotated into the housing 1021 may be controlled according to a relationship between deformation of the first spring A113 and a force to which it is subjected, thereby accurately controlling a magnitude of a force applied by the first spring A113 on the DMD 1024 through the fixing plate 1028 and the circuit board 1027.

In some embodiments, the first screw A1 may be a shoulder screw.

FIG. 24 is a top view of the fixing plate in the optical engine shown in FIG. 22. In some embodiments, as shown in FIG. 24, a bottom surface of the fixing plate 1028 has a rectangular shape, and the fixing plate through holes 1028a may be located at four corners of the fixing plate 1028. The fixing plate through holes 1028a are symmetrical with respect to a symmetry axis of the bottom surface of the fixing plate 1028, so that the first screws A1 installed on the fixing plate 1028 are also symmetrical with respect to the symmetry axis of the bottom surface of the fixing plate 1028, and the bottom surface of the fixing plate 1028 is uniformly stressed.

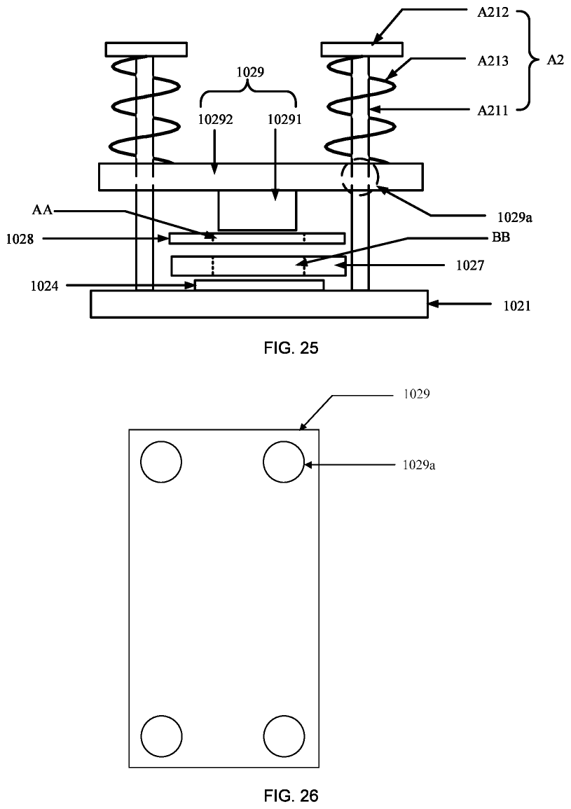

FIG. 25 is a schematic diagram showing a structure of a second screw in the optical engine shown in FIG. 17.

Referring to FIG. 25, each second screw A2 includes a second screw stem A211, a second screw head A212 at an end of the second screw stem A211, and a second spring A213 sleeved on the second screw stem A211. One end of the second spring A213 abuts against the second screw head A212, and the other end thereof abuts against the fixing terminal 10292 of the cooling component 1029. In this case, a depth to which the second screw stem A211 of the second screw A2 is rotated into the housing 1021 may be controlled according to a relationship between deformation of the second spring A213 and a force to which it is subjected, thereby accurately controlling a magnitude of a force applied by the second spring A213 on the DMD 1024 through the cooling terminal 10291.

FIG. 26 is a top view of the cooling component in the optical engine shown in FIG. 22. Referring to FIG. 26, a bottom surface of the fixing terminal 10292 of the cooling component 1029 has a rectangular shape. The fixing terminal through holes 1029a may be located at four corners of the cooling component 1029, and the fixing terminal through holes 1029a are symmetrical with respect to a symmetry axis of the bottom surface of the fixing terminal 10292, so that the second screws A2 installed on the cooling component 1029 are also symmetrical with respect to the symmetry axis of the bottom surface of the cooling component 1029, and the bottom surface of the fixing terminal 10292 of the cooling component 1029 is uniformly stressed.

In some embodiments, the second screw A2 may be a shoulder screw.

It will be noted that, a type of the second screw A2 may be the same as a type of the first screw A1. For example, in a case where the first screw A1 is the shoulder screw, the second screw A2 may also be the shoulder screw. Of course, it can be understood that, the type of the second screw A2 may also be different from the type of the first screw A1. For example, in the case where the first screw A1 is the shoulder screw, the second screw A2 may also be a screw of another type other than the shoulder screw, such as a self-tapping screw.

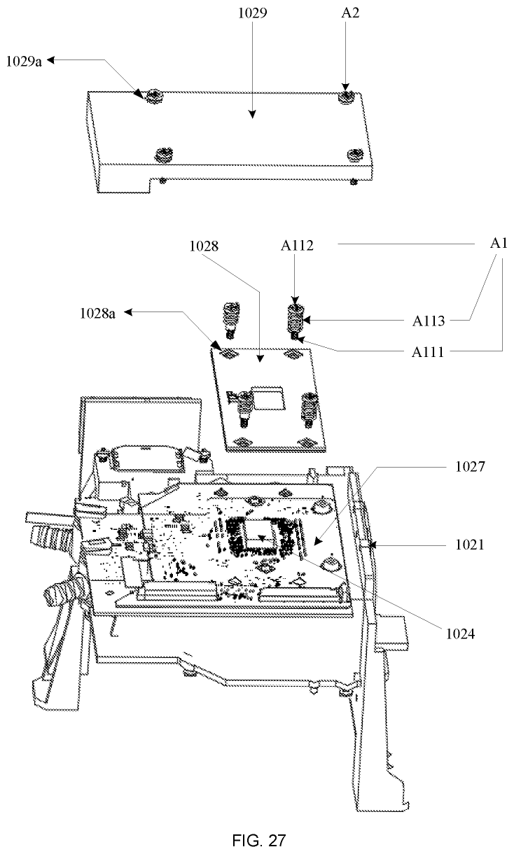

FIG. 27 is an exploded view of the optical engine shown in FIG. 21. In some embodiments, as shown in FIG. 27, with a fixing function of the first screw A1, the first spring A113 in the first screw A1 applies a first pressure to the fixing plate 1028, and the first pressure is transmitted to the bearing region 1024b on the DMD 1024 through the fixing plate 1028 and the circuit board 1027 in sequence; and with a fixing function of the second screw A2, the second spring A213 in the second screw A2 applies a second pressure to the cooling component 1029, and the second pressure is transmitted to the heat dissipation region 1024c on the DMD 1024 through the fixing terminal 10291 and the cooling terminal (not shown in FIG. 27) of the cooling component 1029 in sequence. In some embodiments, a relationship between the first pressure and the second pressure satisfies that a sum of the first pressure and the second pressure is less than a maximum pressure that the DMD 1024 is able to bear, so as to ensure that the DMD 1024 is not damaged due to that it is unable to bear the external pressure.

As shown in FIG. 17, since a portion of the DMD 1024 corresponding to the bearing region 1024b is also supported by the housing 1021, and a portion of the DMD 1024 corresponding to the heat dissipation region 1024c is not supported, a maximum pressure that the bearing region 1024b is able to bear is much greater than a maximum pressure that the heat dissipation region 1024c is able to bear. Therefore, in some embodiments, the first pressure may be much greater than the second pressure. For example, the first pressure is greater than twice of the second pressure. In this way, on one hand, the DMD 1024 may be firmly fixed on the housing 1021, and on another hand, this is beneficial to protecting the DMD 1024. Reasons are that: the maximum pressure that DMD 1024 is able to bear is a fixed value, and thus the larger the first pressure is, the smaller the second pressure is, in which case the second pressure may be reduced by increasing the first pressure, so as to reduce the second pressure to which the heat dissipation region 1024c of the DMD 1024 is subjected as much as possible and prevent the DMD 1024 from being damaged; and in addition, since an acting force between the cooling terminal 10291 and the DMD 1024 when the cooling terminal 10291 shakes is usually a friction force, and a friction force to which an object is subjected is usually increased due to an increase in pressure, by reducing the second pressure applied by the cooling terminal on the DMD 1024 as much as possible, it may be possible to avoid an excessively large friction force applied to the heat dissipation surface of DMD 1024 when the cooling terminal shakes (the excessively large friction force is caused by an excessively large second pressure from the cooling terminal which is applied to the heat dissipation region 1024c of the DMD 1024), thereby avoiding occurrence of displacement of the DMD 1024 with the cooling assembly 1029, and increasing firmness of fixing the DMD 1024.

Considering the laser projection apparatus shown in FIG. 27 as an example, in some embodiments of the present disclosure, steps of installing the DMD 1024 on the housing 1021 may include S1 to S2.

In S1, the DMD, the circuit board and the fixing plate are fixed to the housing, which includes the following four steps, i.e., S11 to S14.

In S11, the DMD 1024 is placed on the housing 1021 in a way that the beam receiving surface 1024a is corresponding to the accommodating cavity opening 1021b, the beam receiving surface 1024a of the DMD 1024 faces the accommodating cavity 1021a enclosed by the housing 1021, and the beam receiving surface 1024a is exposed to the accommodating cavity 1021a through the accommodating cavity opening 1021b.

In S12, the circuit board 1027 is placed on the heat dissipation surface of the DMD 1024, the second opening BB of the circuit board 1027 exposes the heat dissipation region 1024c of the heat dissipation surface of the DMD 1024, and the circuit board 1027 is in contact with the bearing region 1024b of the heat dissipation surface of the DMD 1024.

In S13, the fixing plate 1028 is placed on the circuit board 1027, and the first opening AA of the fixing plate 1028 is aligned with the second opening BB of the circuit board 1027, so that the heat dissipation region 1024c of the DMD 1024 is exposed through the first opening AA and the second opening BB; and it will be noted that, in a case where the first opening AA is aligned with the second opening BB, the plurality of fixing plate through holes 1028a in the fixing plate 1028 and the plurality of circuit board through holes 1027a in the circuit board 1027 are also in one-to-one correspondence and aligned.

In S14, make the plurality of first screws A1 and the plurality of fixing plate through holes 1028a in the fixing plate 1028 in one-to-one correspondence. In this case, since the plurality of fixing plate through holes 1028a and the plurality of circuit board through holes 1027a are in one-to-one correspondence and aligned, the plurality of first screws A1 and the plurality of circuit board through holes 1027a in the circuit board 1027 are also in one-to-one correspondence. Each first screw A1 sequentially passes through a corresponding fixing plate through hole 1028a and a corresponding circuit board through hole 1027a, and then is fixed in the housing 1021. The first screw A1 may apply the first pressure to the fixing plate 1028, and the first pressure may press the fixing plate 1028, the circuit board 1027 and the DMD 1024 on the housing 1021, during which a magnitude of the force applied to the bearing region 1024b of the DMD 1024 may be accurately controlled through the first spring A113.

In S2, the cooling component is fixed to the housing, which includes the following two steps, i.e., S21 to S22.

In S21, the cooling component 1029 is placed above the fixing plate 1028, and the orthogonal projection of the cooling component 1029 on the housing 1021 and the orthogonal projections of the plurality of first screws A1 on the housing 1021 are made not to overlap, and the orthogonal projections of the plurality of second screws A2 on the housing 1021 and the orthogonal projection of the fixing plate 1028 on the housing 1021 are made not to overlap. For example, in a case where the numbers of the first screws A1 and the second screws A2 are both four, the cooling component 1029 is placed above the fixing plate 1028, and the orthogonal projection of the cooling component 1029 on the housing 1021 and orthogonal projections of the four first screws A1 on the housing 1021 are made not to overlap, and orthogonal projections of the four second screws A2 on the housing 1021 and the orthogonal projection of the fixing plate 1028 on the housing 1021 are made not to overlap.

In S22, the cooling terminal 10291 of the cooling component 1029 sequentially passes through the first opening AA of the fixing plate 1028 and the second opening BB of the circuit board 1027, so that the cooling terminal 10291 is in contact with the heat dissipation region 1024c of the DMD 1024. The plurality of second screws A2 pass through the plurality of fixing terminal through holes 1029a in the fixing terminal 10292 of the cooling component 1029 in one-to-one correspondence, and the second screws A2 are fixed on the housing 1021. The second screw A2 may apply the second pressure to the cooling component 1029 by applying the second pressure to the fixing terminal 10292. The second pressure may press the cooling terminal 10291 of the cooling component 1029 on the heat dissipation region 1024c of the DMD 1024, so that the cooling terminal 10291 is in contact with the heat dissipation region 1024c, during which a magnitude of the force applied to the heat dissipation region 1024c of the DMD 1024 may be accurately controlled through the second spring A213.

It can be seen therefrom that in some embodiments of the present disclosure, the cooling component 1029 and the housing 1021 may be separately fixed, and the DMD 1024 and the housing 1021 may be separately fixed. In this case, even if the laser projection apparatus shakes, since the DMD 1024 and the cooling component 1029 are separately fixed to the housing 1021, the position of the DMD 1024 in the optical engine 102 is no longer affected by the external force applied by the cooling component 1029, thereby avoiding the shift of the position of the DMD 1024 caused by the shaking of the cooling component 1029, improving the firmness of installing the DMD 1024, and ensuring normal implementation of the beam path in the laser projection apparatus.

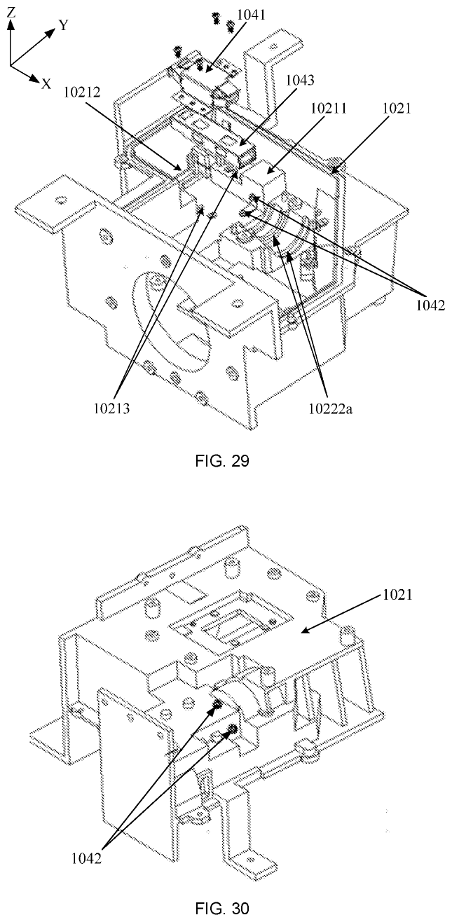

In some embodiments of the present disclosure, the laser projection apparatus further includes a lens assembly fixing device. FIG. 29 is a schematic diagram showing a structure of a lens assembly fixing device in a laser projection apparatus, in accordance with some embodiments of the present disclosure. Referring to FIG. 29, the lens assembly fixing device includes a contoured groove 10222a corresponding to the lens assembly 10222, and the contoured groove 10222a is located on the housing 1021. A shape of the contoured groove 10222a is matched with a shape of the lens assembly 10222. For example, in a case where an outer contour of the lens assembly 10222 has a circular shape, the contoured groove 10222a has a circular arc shape, such as a semicircular shape.

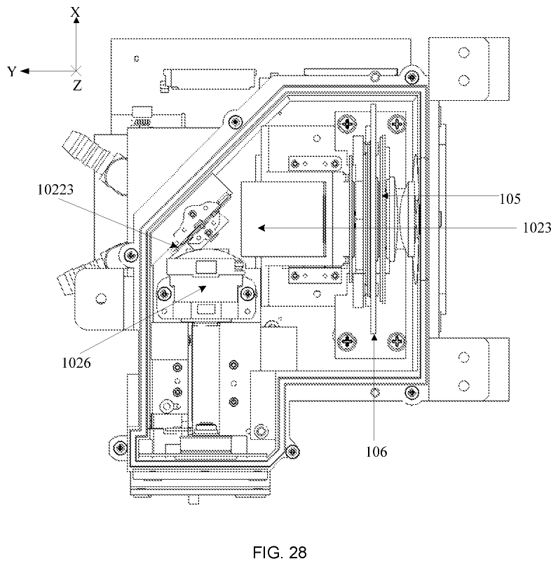

FIG. 28 is a schematic diagram showing a partial structure of a laser projection apparatus, in accordance with some embodiments of the present disclosure. Referring to FIG. 28, the optical engine 102 further includes a contoured cover plate 1026 corresponding to the lens assembly 10222. A shape of the contoured cover plate 1026 is matched with the shape of the lens assembly 10222. For example, in the case where the outer contour of the lens assembly 10222 has the circular shape, the contoured cover plate 1026 has a circular arc shape, such as a semicircular shape.

The contoured cover plate 1026 may be snap-fitted with the contoured groove 10222a to form a contoured cavity. A shape and a size of the contoured cavity are the same as or substantially the same as those of the lens assembly 10222. Therefore, by placing the lens assembly 10222 into the contoured groove 10222a, and snap-fitting the contoured cover plate 1026 with the contoured groove 10222a, the lens assembly 10222 may be fixed in the contoured cavity, thereby achieving a purpose of fixing the lens assembly 10222 to the housing 1021, and avoiding shaking of the lens assembly 10222 relative to the housing 1021.

Based on the above method of fixing the lens assembly 10222, in a case of severe shaking of the housing 1021, the lens assembly 10222 may still be damaged due to collision with the contoured cover plate 1026 or the contoured groove 10222a, in which case the projection apparatus may not be able to project an image normally. In order to avoid occurrence of the above situation, in some embodiments, an inner side wall of the contoured cover plate 1026 is provided with a flexible layer, so as to buffer an acting force from the contoured cover plate 1026 and/or the contoured groove 10222a to which the lens assembly 10222 is subjected through the flexible layer, and to effectively prevent the lens assembly 10222 from being damaged. Of course, a flexible layer may also be provided on an inner side wall of the contoured groove 10222a.

In some embodiments, the flexible layer may be made of rubber.

In some embodiments, referring to FIGS. 3 and 8, it can be seen that the lens assembly 10222 includes a first lens 102221 and a second lens 102222. The first lens 102221 is closer to the light pipe 10221 than the second lens 102222.

As shown in FIG. 8, the first lens 102221 is configured to perform a first contraction on the received illumination beams homogenized (or homogenized and shaped) by the light pipe 10221. It will be noted that, before passing through the first lens 102221, the illumination beams first enter the light pipe 10221 from the beam inlet of the light pipe 10221, and then emit from the beam outlet of the light pipe 10221 and are directed to the first lens 102221. Since an area of a beam spot of illumination beams after passing through the first lens 102221 is greater than an area of a beam spot of illumination beams passing through the beam outlet, the first lens 102221 actually amplifies the illumination beams.

As shown in FIG. 8, the second lens 102222 is configured to perform a second contraction on the received illumination beams that pass through the first lens 102221 and are diverged. It will be noted that, since an area of a beam spot of illumination beams after passing through the second lens 102222 is smaller than an area of a beam spot of illumination beams before entering the second lens 102222 (which may also be regarded as the illumination beams after passing through the first prism 102221), the second lens 102222 actually converges the illumination beams.

In some embodiments, the first lens 102221 includes a first face close to the light pipe and a second face away from the light pipe. The first face protrudes toward the second face, and a protruding direction of the second face is the same as a protruding direction of the first face. The second lens 102222 includes a third face close to the light pipe and a fourth face away from the light pipe. The third face protrudes in a direction away from the fourth face, and a protruding direction of the fourth face is opposite to a protruding direction of the third face.

In some embodiments, the first lens 102221 and the second lens 102222 may be spherical lenses, or may be aspherical lenses. For example, the first lens 102221 may be an aspherical concave convex lens (or referred to as a positive meniscus lens), and the second lens 102222 may be an aspherical biconvex lens.

For example, as shown in FIG. 8, in a case where the first lens 102221 is a concave convex lens, the first face of the first lens 102221 close to the light pipe 10221 protrudes toward a side away from the light pipe 10221. The second face of the first lens 10221 also protrudes toward the side away from the light pipe 10221, and an absolute value of curvature of the second face is greater than an absolute value of curvature of the first face. The third face of the second lens 10232 close to the light pipe 10221 protrudes toward a side close to the light pipe 10221, and the fourth face of the second lens 102222 away from the light pipe 10221 protrudes toward a side away from the light pipe 10221.

In some embodiments, a first propagation direction of the illumination beams contracted by the second lens 102222 (i.e., a propagation direction of the illumination beams irradiating the reflector 10223) is parallel to the extension direction of the light pipe 10221. That is, the illumination beams exit in a direction parallel to an optical axis of the second lens 102222. In this case, after irradiating the reflector 10223, the illumination beams exiting from the second lens 102222 are reflected by the reflector 10223 to the first incident surface 10231a of the first prism 10231, and may be reflected by the first exit surface 10231b of the first prism 10231.

Of course, there may also be a certain included angle between the first propagation direction of the illumination beams contracted by the second lens 102222 and the extension direction of the light pipe 10221, as long as it is ensured that the illumination beams are reflected by the first exit surface 10231b of the first prism 10231. The included angle is, for example, in a range of 0° to 20°, inclusive.

In some embodiments, an included angle between the first propagation direction of the illumination beams irradiating the reflector 10223 and a second propagation direction of the illumination beams reflected by the reflector 10223 may be greater than or equal to 80°.

For example, the included angle between the first propagation direction of the illumination beams irradiating the reflector 10223 and the second propagation direction of the illumination beams reflected by the reflector 10223 is 90°. That is to say, the first propagation direction of the illumination beams irradiating the reflector 10223 is perpendicular to the second propagation direction of the illumination beams reflected by the reflector 10223.

In some embodiments of the present disclosure, the laser projection equipment further includes a light pipe fixing device. FIG. 29 is a schematic diagram showing a structure of a light pipe fixing device in a laser projection apparatus, in accordance with some embodiments of the present disclosure. Referring to FIG. 29, the light pipe fixing device includes: a fixing assembly 1041 configured to fix the light pipe 10221 on the housing 1021, at least one adjusting screw 1042, and a tubular light pipe bearing assembly 1043 (also referred to as an iron coat, i.e., a rigid protector that is sleeved on the light pipe). The light pipe bearing assembly 1043 is equipped with the light pipe 10221 therein.

A part of the at least one adjusting screw 1042 is located inside the accommodating cavity 1021a enclosed by the housing 1021, and the other part is located outside the accommodating cavity 1021a enclosed by the housing 1021. FIG. 30 is a schematic diagram showing a bottom of the housing in FIG. 29. As shown in FIG. 30, the housing 1021 includes two threaded through holes, and two adjusting screws 1042 pass through the two threaded through holes in the housing 1021 to be inserted into the accommodating cavity enclosed by the housing 1021. One end of each adjusting screw 1042 inserted into the housing 1021 abuts against an outer wall of the light pipe bearing assembly 1043, and the other end of the adjusting screw 1042 is located outside the housing 1021. When a position of the light pipe 10221 is subsequently adjusted, the adjusting screws 1042 may be directly operated from the outside of the housing 1021.

Generally, after adjusting the position of the light pipe 10221, the adjusting screws 1042 may be fixed by using an adhesive dispensing method. In an else case where the whole adjusting screws 1042 are arranged in the accommodating cavity 1021a enclosed by the housing 1021, a temperature of the accommodating cavity 1021a needs to be increased in order to volatilize the adhesive at a high temperature, which easily causes damage to performance of other components in the accommodating cavity 1021a due to the increased temperature, thereby affecting a service life of the laser projection apparatus. However, in some embodiments of the present disclosure, a part of the adjusting screws are located in the accommodating cavity 1021a, and the other part are located outside the accommodating cavity 1021a. This makes it possible to fix and seal the adjusting screws 1042 directly from the outside of the accommodating cavity 1021a when the adjusting screws 1042 are fixed by using the adhesive dispensing method. In this case, a volatilization process of the adhesive is also performed outside the accommodating cavity 1021a, which does not affect the components in the accommodating cavity 1021a, thereby effectively extending the service life of the laser projection apparatus.

Referring to FIG. 29, the fixing assembly 1041 is fixedly connected to the housing 1021, and fixes the light pipe bearing assembly 1043 inside the housing 1021. Since the light pipe 10221 is nested in the light pipe bearing assembly 1043, in a case where the light pipe bearing assembly 1043 is fixed to the housing 1021, the light pipe 10221 is also fixed to the housing 1021.

Herein, it will be noted that, since the light pipe 10221 has a transparent pipelike shape, and is usually made of a material such as transparent glass or polymethyl methacrylate (PMMA), and is fragile and easily broken, if the adjusting screw 1042 directly abuts against an outer wall of the light pipe 10221, the light pipe 10221 will be easily damaged due to an acting force from the adjusting screw 1042 during the adjustment of the position of the light pipe 10221 by using the adjusting screw 1042. By abutting one end of the adjusting screw 1042 against the outer wall of the light pipe bearing assembly 1043 instead of directly abutting the adjusting screw 1042 against the light pipe 10221, the light pipe 10221 may be better protected and a probability of damage to the light pipe 10221 may be reduced.

In some embodiments, as shown in FIG. 29, the optical engine 102 includes an L-shaped barrier wall 10211 located in the accommodating cavity 1021a. Two adjacent side walls of the light pipe bearing assembly 1043 abut against an inner wall of the fixing assembly 1041, and the other two adjacent side walls abut against the L-shaped barrier wall 10211 and the housing 1021. For example, in FIG. 29, as viewed opposite to a positive direction of the X axis and from the observer's view, it can be observed that upper and left side walls of the light pipe bearing assembly 1043 abut against the inner wall of the fixing assembly 1041, a right side wall thereof abuts against a left side wall of the L-shaped barrier wall 10211, and a lower side wall thereof abuts against the inner wall of the housing 1021.

Referring to FIG. 29, the L-shaped barrier wall 10211 is shaped like a letter “L”. An L-shaped stepped surface of the L-shaped barrier wall 10211 is configured to install the fixing assembly 1041. It can be understood that, the L-shaped barrier wall 10211 and the housing 1021 may be of an integral structure, or the L-shaped barrier wall 10211 may be provided separately.

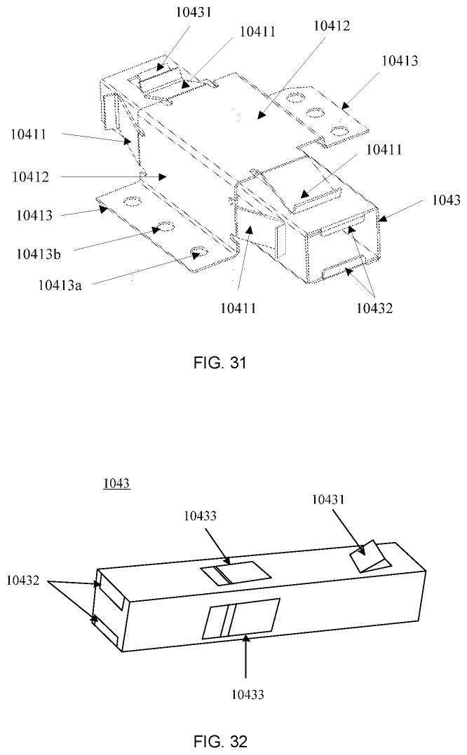

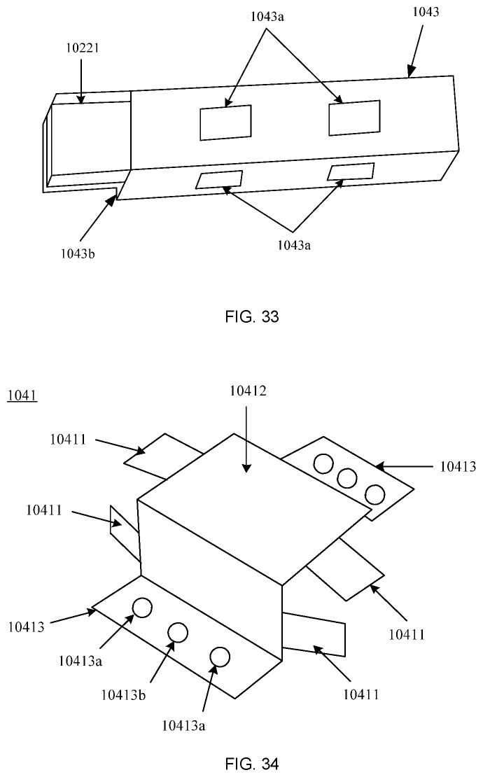

FIG. 31 is a schematic diagram showing a structure of the fixing assembly and the light pipe bearing assembly in the laser projection apparatus, in accordance with some embodiments of the present disclosure. FIGS. 32 and 33 are schematic diagrams showing structures of the light pipe bearing assembly in the laser projection apparatus, in accordance with some embodiments of the present disclosure. FIG. 34 is a schematic diagram showing a structure of the fixing assembly in the laser projection apparatus, in accordance with some embodiments of the present disclosure. In some embodiments, referring to FIGS. 31 to 34, the light pipe bearing assembly 1043 has a rectangular tubular shape, and the outer wall of the light pipe bearing assembly 1043 includes four side walls enclosing the rectangular tubular shape. The fixing assembly 1041 includes at least two adjusting elastic sheets 10411, which abut against two adjacent side walls of the light pipe bearing assembly 1043. For example, the fixing assembly 1041 in FIG. 31 includes four adjusting elastic sheets 10411, in which two adjusting elastic sheets 10411 abut against the upper side wall of the light pipe bearing assembly 1043, and the other two adjusting elastic sheets 10411 abut against the left side wall of the light pipe bearing assembly 1043, so that the right side wall and the lower side wall of the light pipe bearing assembly 1043 may be pressed against the L-shaped barrier wall 10211 and the housing 1021 respectively, thereby achieving a purpose of fixing the light pipe bearing assembly 1043 to the housing 1021.

In some embodiments, referring to FIGS. 32 and 33, the light pipe bearing assembly 1043 has a same shape as the light pipe 10221, so that the light pipe bearing assembly 1043 may be more attached to the light pipe 10221 after the light pipe 10221 is nested, and space between the light pipe 10221 and the light pipe bearing assembly 1043 is as small as possible, thereby fixing the light pipe 10221 in the light pipe bearing assembly 1043 more stably, and increasing firmness of fixing the light pipe 10221 to the housing 1021; moreover, it may also be possible to prevent collision between the light pipe 10221 and the light pipe bearing assembly 1043 caused by an excessively large space between the light pipe 10221 and the light pipe bearing assembly 1043, which causes the light pipe 10221 to be damaged. In addition, by abutting the adjusting screws 1042 against the outer wall of the light pipe bearing assembly 1043, not only the position of the light pipe 10221 may be slightly adjusted, but also the light pipe 10221 may be protected from being damaged during the adjustment.

In addition, since the light pipe bearing assembly 1043 is attached to the light pipe 10221, and the adjusting screws 1042 abut against two adjacent side walls of the light pipe bearing assembly, when the light pipe bearing assembly 1043 is pushed during the adjustment, the light pipe 10221 is also pushed, thereby achieving a purpose of adjusting the position of the light pipe 10221.

Generally, if the adjusting elastic sheets 10411 directly contact the light pipe bearing assembly 1043, it may be possible to cause the adjusting elastic sheets 10411 to slide on the outer wall of the light pipe bearing assembly 1043 without pushing the light pipe bearing assembly 1043 to move during the adjustment of the position of the light pipe bearing assembly 1043, thereby affecting accuracy of a result of adjusting the position of the light pipe bearing assembly 1043.

For this purpose, in some embodiments, as shown in FIGS. 31 and 32, the light pipe bearing assembly 1043 includes protruding structure(s) 10431 located on side wall(s) thereof. A protruding structure 10431 protrudes toward an outside of the light pipe bearing assembly 1043, and is configured to abut against an adjusting elastic sheet 10411. The protruding structure(s) 10431 may prevent the adjusting elastic sheets 10411 from sliding on the outer wall of the light pipe bearing assembly 1043, increase firmness of fixing the light pipe bearing assembly 1043 through the fixing assembly 1041, and ensure the accuracy of the result of adjusting the position of the light pipe bearing assembly 1043.

In order to enable the adjusting elastic sheets 10411 of the fixing assembly 1041 to abut against the protruding structure(s) 10431, the protruding structure(s) 10431 need to be arranged on the side wall(s) of the light pipe bearing assembly 1043 that abut against the fixing assembly 1041. The number of the protruding structure(s) 10431 may or may not correspond to the number of the adjusting elastic sheets 10411.

In some embodiments, as shown in FIGS. 31 and 32, the light pipe bearing assembly 1043 further includes light pipe barrier walls 10432 at an end thereof. For example, it includes two light pipe barrier walls 10432. The two light pipe barrier walls 10432 may be arranged opposite to each other (as shown in FIGS. 31 and 32), or may be arranged adjacent to each other. In directions perpendicular to side walls of the light pipe bearing assembly 1043 connected to the light pipe barrier walls 10432, a height of the light pipe barrier walls 10432 is smaller than a thickness of a pipe wall of the light pipe 10221, so as to avoid affecting the beams exiting from the light pipe 10221. In some embodiments, the light pipe is a hollow tubular structure with four side walls. In some embodiments, the light pipe is a solid structure with four side faces.

After the light pipe 10221 is pushed into the light pipe bearing assembly 1043 from an end of the light pipe bearing assembly 1043 that is provided with no light pipe barrier walls 10432, the light pipe 10221 cannot be pushed further after touching the light pipe barrier walls 10432, so as to effectively ensure that the light pipe 10221 is nested at a predetermined position.

In some embodiments, since the light pipe 10221 has the transparent pipelike shape and the pipe wall has a thickness, after entering the light pipe, the illumination beams emitted by the laser source 101 not only propagate in space enclosed by the pipe wall of the light pipe 10221, but also enter the pipe wall of the light pipe 10221 and propagate in the pipe wall. Generally, since a refractive index of the pipe wall is different from a refractive index of a medium (e.g., air) in the space enclosed by the pipe wall, the illumination beams no longer propagate in a single form. For example, the illumination beams may propagate in various forms such as reflection and refraction when entering the pipe wall from the space enclosed by the pipe wall, which causes the beams in the pipe wall to be disordered and affects an effect of propagating the beams by the light pipe 10221. In this case, by providing the barrier walls 10432, the beams exiting from one end of the pipe wall of the light pipe 10221 may be blocked, so as to prevent the disordered beams exiting from the pipe wall of the light pipe 10221 from entering a next optical element, and to effectively eliminate stray beams generated in a process of propagating the illumination beams by the light pipe 10221.

In some embodiments, as shown in FIG. 32, the light pipe bearing assembly 1043 further includes clamping claws 10433 located on side walls thereof. The clamping claws 10433 are bent toward an inside of the light pipe bearing assembly 1043, and are configured to abut against the light pipe 10221, so as to press the light pipe 10221 against side walls of the light pipe bearing assembly 1043 that are provided with no clamping claws, thereby achieving a purpose of fixing the light pipe 10221 to the light pipe bearing assembly 1043. In some embodiments, the light pipe bearing assembly 1043 includes two clamping claws 10433. The two clamping claws 10433 are located on two side walls of the light pipe bearing assembly respectively, and the two side walls are adjacent. However, the embodiments of the present disclosure are not limited thereto. The light pipe bearing assembly 1043 may also include more than two clamping claws, and these clamping claws may also be located on two opposite side walls, or on three adjacent side walls, or on only one side wall of the light pipe bearing assembly.

In some embodiments, a clamping claw 10433 includes a fixed end and a free end. The fixed end of the clamping claw 10433 is fixedly connected to or integrally formed with a side wall of the light pipe bearing assembly 1043, and the free end of the clamping claw 10433 is bent toward the inside of the light pipe bearing assembly 1043. Moreover, in a case where the light pipe bearing assembly 1043 includes the light pipe barrier walls 10432, the free end is closer to the light pipe barrier walls 10432 than the fixed end. In this way, when the light pipe 10221 is pushed into the light pipe bearing assembly 1043 from the end of the light pipe bearing assembly 1043 that is provided with no light pipe barrier walls 10432, the free end of the clamping claw 10433 does not hinder movement of the light pipe.

Referring to FIG. 33, the light pipe bearing assembly 1043 further includes at least one side wall opening 1043a. The at least one side wall opening 1043a is configured to introduce an adhesive to space between the light pipe bearing assembly 1043 and the light pipe 10221, so that the light pipe bearing assembly 1043 and the light pipe 10221 are bonded together through the adhesive. The side wall opening 1043a may have a rectangular shape or any other shape, which is not limited in the embodiments of the present disclosure. After the light pipe 10221 is nested in the light pipe bearing assembly 1043, there is usually a gap between the light pipe 10221 and an inner surface of a side wall of the light pipe bearing assembly 1043. In this case, the adhesive may be injected from the side wall opening 1043a to more firmly fix the light pipe 10221 inside the light pipe bearing assembly 1043.

In some embodiments, the adhesive may be, for example, a shadowless adhesive (a UV adhesive, also referred to as a photosensitive adhesive), or any other adhesive, which is not limited in the embodiments of the present disclosure.

In some embodiments, as shown in FIG. 33, side wall openings 1043a may be located on the side walls of the light pipe bearing assembly 1043 that are provided with no clamping claws 10433. When the clamping claws 10433 press the light pipe 10221 against the side walls of the light pipe bearing assembly 1043 that are provided with no clamping claws, distances between the light pipe 10221 and the side walls of the light pipe bearing assembly 1043 that are provided with no clamping claws 10433 are small, and gaps between the light pipe 10221 and the side walls of the light pipe bearing assembly 1043 that are provided with no clamping claws 10433 may be filled by using a small amount of adhesive. The number of the side wall openings 1043a is four. In the two side walls that are provided with no clamping claws 10433, each side wall includes two side wall openings 1043a. In this case, by injecting the adhesive from the plurality of side wall openings 1043a, the light pipe 10221 and the light pipe bearing assembly 1043 may be bonded more evenly through the adhesive.

Of course, it can be understood that, in some embodiments, the side wall openings 1043a may also be provided on the four side walls of the light pipe bearing assembly 1043, which is not limited in the embodiments of the present disclosure.

In some embodiments, the light pipe bearing assembly 1043 includes the protruding structure(s) 10431, the clamping claws 10433, and the side wall openings 1043a, all of which are located on the side walls of the light pipe bearing assembly 1043. However, the embodiments of the present disclosure do not limit a positional relationship among the protruding structure(s) 10431, the clamping claws 10433, and the side wall openings 1043a. Generally, the side wall openings 1043a may be arranged on the side walls of the light pipe bearing assembly 1043 that are provided with no clamping claws 10433; and the protruding structure(s) 10431 are distributed on the plurality of side walls of the light pipe bearing assembly 1043 as evenly as possible, so as to prevent a strength of a certain side wall of the light pipe bearing assembly 1043 from being reduced due to removal of excessive material.

In some embodiments, the light pipe bearing assembly 1043 is fabricated by using a sheet metal process. Since thicknesses of respective portions of a sheet metal part fabricated by using the sheet metal process are the same, thicknesses of respective portions of the light pipe bearing assembly 1043 are the same. In some embodiments, the light pipe bearing assembly 1043 is made of a metal material, which may be, for example, iron, aluminum, stainless steel, or galvanized steel. The embodiments of the present disclosure do not limit the material of the light pipe bearing assembly.

Referring to FIGS. 31 and 34, the fixing assembly 1041 includes blocking plates 10412 and connecting plates 10413. The blocking plates 10412 are configured to surround the side walls of the light pipe bearing assembly 1043. The connecting plates 10413 are configured to be connected to the housing 1021 to fix the fixing assembly 1041 to the housing 1021. In some embodiments, the fixing assembly 1041 includes two blocking plates 10412 connected to each other and two connecting plates 10413 connected to the two blocking plates respectively. After the two blocking plates 10412 are connected to each other, a certain included angle is formed between them, so that cross sections of the two blocking plates 10412 connected to each other form an L shape. A magnitude of the included angle is in a range of 80° to 100° inclusive, such as 85°, 90°, or 95°. A predetermined included angle is formed between each connecting plate 10413 and a blocking plate 10412 connected to the connecting plate 10413. A magnitude of the predetermined included angle is in a range of 80° to 100° inclusive, such as 85°, 90°, or 95°.

As shown in FIGS. 31 and 34, the connecting plate 10413 includes threaded holes 10413a, so that screws may be threaded with the housing 1021 through the threaded holes 10413a, and a purpose of fixing the connecting plate 10413 to the housing 1021 may be achieved. Of course, the threaded holes 10413a may also be replaced by unthreaded holes. In a case where the light pipe bearing assembly 1043 is fixed on the housing 1021 through the fixing assembly 1041, as shown in FIGS. 29 and 31, the upper side wall and the left side wall of the light pipe bearing assembly 1043 are adjacent to the two blocking plates 10412, and the right side wall and the lower side wall of the light pipe bearing assembly 1043 are adjacent to the L-shaped barrier wall 10211 and the housing 1021 respectively. Due to joint action of the two blocking plates 10412, the L-shaped barrier wall 10211, and the housing 1021, four sides of the light pipe bearing assembly 1043 are all fixed.

In some embodiments, the fixing assembly 1041 may further include three blocking plates 10412 connected in sequence. The three blocking plates 10412 form a rectangular frame with an open side, and the rectangular frame is connected to the two connecting plates 10413. In this case, the upper side wall, the left side wall and the right side wall of the light pipe bearing assembly 1043 are adjacent to the three blocking plates 10412, and the lower side wall of the light pipe bearing assembly 1043 is adjacent to the housing 1021.

Since the space inside the accommodating cavity 1021a enclosed by the housing 1021 is small, a size of the fixing assembly 1041 is also required to be small, and thus the connecting plate 10413 of the fixing assembly 1041 cannot be provided with too many threaded holes. However, it is difficult to fix the connecting plate 10413 with only one threaded hole. Therefore, in some embodiments, referring to FIGS. 29 and 31, the number of the threaded holes 10413a in each connecting plate 10413 may be two, which not only ensures firmness of fixing the fixing assembly 1041 to the housing 1021 (or the L-shaped barrier wall 10211), but also satisfies the requirement for the small size of the fixing assembly 1041. In addition, it also makes an installation process of the fixing assembly 1041 easier.

It can be understood that, the number of the threaded holes 10413a listed above is only exemplary, and as long as the light pipe bearing assembly 1043 may be fixed to the housing 1021 and the L-shaped barrier wall 10211, the embodiments of the present disclosure do not limit the number of the threaded holes 10413a in each fixing assembly 1041.

In some embodiments, referring to FIGS. 29 and 31, the connecting plate 10413 of the fixing assembly 1041 further include a positioning hole 10413b, the housing 1021 and the L-shaped barrier wall 10211 each further include a positioning protrusion 10213 corresponding to the positioning hole 10413b, and the positioning protrusion 10213 is able to assist in determining a position of the fixing assembly 1041 in the accommodating cavity 1021a. For example, after the positioning protrusion 10213 passes through the positioning hole 10413b, the position of the fixing assembly 1041 in the accommodating cavity 1021a may be determined, so that differences of beam propagation caused by differences of positions of fixing assemblies in different laser projection apparatuses may be avoided. As shown in FIGS. 31 and 34, the positioning hole 10413b is located between any two threaded holes 10413a of the plurality of threaded holes 10413a in the connecting plate 10413. In a case where the number of the threaded holes 10413a in each connecting plate 1041 is two, the positioning hole 10413b is located between the two threaded holes 10413a.

It will be noted that, as shown in FIG. 29, the L-shaped barrier wall 10211 has a step. In the extension direction of the Z axis, the step includes a first step surface at a higher position and a second step surface at a lower position. The first step surface and the second step surface form an L shape, and thus the barrier wall is referred to as the L-shaped barrier wall. The positioning protrusion 10213 is located on the second step surface. In a case where a connecting plate 10413 of the fixing assembly 1041 is fixed on the L-shaped barrier wall 10211, the connecting plate 10413 abuts against a connecting surface connecting the first step surface and the second step surface, and the connecting surface is parallel to the extension direction of the Z axis, so that movement of the fixing assembly in the accommodating cavity 1021a is limited.

Referring to FIGS. 29, 31 and 34, the fixing assembly 1041 includes the adjusting elastic sheets 10411. The adjusting elastic sheets 10411 are configured to abut against the light pipe bearing assembly 1043 and cooperate with the adjusting screws 1042 to adjust the position of the light pipe 10221, so that the light pipe 10221 is aligned with the lens assembly 10222 downstream of the beam path. It will be noted that, the adjusting elastic sheets 10411 and the adjusting screws 1042 are arranged symmetrically; when the adjusting screws 1042 are screwed into the housing 1021, the light pipe 10221 moves along with the adjusting screws 1042, so that the adjusting elastic sheets 10411 are pressed to retreat in advancing directions of the adjusting screws 1042; and when the adjusting screws 1042 are screwed out of the housing 1012, the light pipe 10221 moves due to action of restoring force of the adjusting elastic sheets 10411, and the elastic sheets 10411 advance in retreating directions of the adjusting screws.

In some embodiments, the fixing assembly 1041 includes four adjusting elastic sheets 10411, and each blocking plate 10412 is connected to two adjusting elastic sheets 10411. In FIG. 29, the four adjusting elastic sheets 10411 are arranged on an upper side and a left side of the light pipe 10221, and then two adjusting screws 1042 are arranged on a lower side and a right side of the light pipe 10221.

In some embodiments, due to an error of a position of the beam inlet 10221a of the light pipe 10221, part of the illumination beams cannot enter the optical engine, which in turn causes loss of the illumination beams emitted by the laser source 101 to increase and a utilization rate of the illumination beams to decrease. In order to avoid the above situation, referring to FIG. 29 again, the housing 1021 includes an L-shaped positioning structure 10212 located in the accommodating cavity 1021a, and the L-shaped positioning structure 10212 is located on a side of the accommodating cavity 1021a close to the laser source 101. In FIG. 29, the L-shaped positioning structure 10212 includes a lower side and a right side. As shown in FIG. 33, two adjacent side walls of the light pipe bearing assembly 1043 include a positioning notch 1043b. The beam inlet 10221a of the light pipe 10221 is configured to be located near the positioning notch 1043b. An end of the light pipe 10221 where the beam inlet 10221a is located is exposed from the positioning notch 1043b. After being placed on the L-shaped positioning structure 10212, the end abuts against the L-shaped positioning structure 10212.

The end of the light pipe 10221 with the beam inlet 10221a is located on the side of the accommodating cavity 1021a close to the laser source 101. The end of the light pipe 10221 with the beam inlet 10221a is positioned through the L-shaped positioning structure 10212. In this way, the position of the beam inlet 10221a of the light pipe 10221 in the accommodating cavity 1021a may be accurately determined, the error of the position of the beam inlet 10221a of the light pipe 10221 may be prevented during installation or use, it may be possible to facilitate collection of the illumination beams emitted by the laser source 101 by the light pipe 10221, and a positioning process of the light pipe 10221 may be effectively simplified when the light pipe 10221 is installed.

A resolution of an image projected by the laser projection apparatus affects a projection effect of the laser projection apparatus. The larger the resolution of the projected image is, the better the projection effect is. Generally, in order to improve the resolution, there is a need to increase the number of pixels of the image projected by the laser projection apparatus. A current solution is to provide a vibrating lens in a beam path between the prism assembly 1023 and the projection lens 103. After the laser projection apparatus is powered on, the vibrating lens is able to periodically vibrate according to received electrical signals, and project a projection beam corresponding to a pixel for multiple times, and sequentially inject multiple projection beams of a same pixel into the projection lens, thereby achieving a purpose of displaying a single pixel for multiple times. For example, the pixel is displayed at position P1 at time T1 and displayed at position P2 at time T2. Due to a limited resolution of the human eyes, a process of displaying a single pixel for multiple times cannot be distinguished, so that the resolution of the laser projection apparatus is improved.

However, the following problem also arises: since the vibrating lens is fixed to the housing of the optical engine through a vibrating lens bracket, in a case of the periodic vibration of the vibrating lens, the vibration is sequentially transmitted to the vibrating lens bracket and the housing, which causes the vibrating lens bracket and the housing to vibrate as well, and causes loud noise.

In some embodiments, referring to FIGS. 4 and 28, FIG. 4 is the bottom view of the optical engine and the projection lens of the laser projection apparatus in the normal use state, and FIG. 28 is a top view of the laser projection apparatus with a top of the housing of the optical engine removed in the normal use state. The laser projection apparatus further includes the vibrating lens 105 and the vibrating lens bracket 106. For example, the vibrating lens 105 in the laser projection apparatus shown in FIGS. 4 and 28 is located between the prism assembly 1023 and the projection lens 103. The vibrating lens 105 is configured to periodically vibrate when driven by electric signals, so as to project a projection beam corresponding to a pixel for multiple times, and to sequentially inject a plurality of projection beams of a same pixel into the projection lens 103. The vibrating lens 105 is fixed on the housing 1021 through the vibrating lens bracket 106.

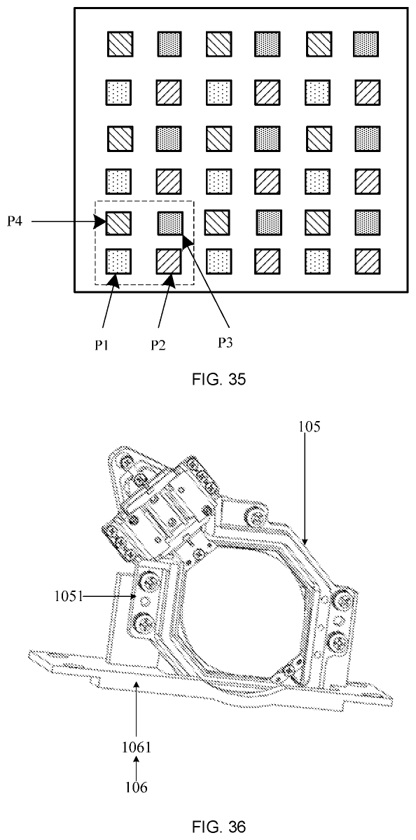

In some embodiments, the vibrating lens 105 is configured to periodically move at four positions when driven by electric signals. For example, as shown in FIG. 35, the vibrating lens 105 sequentially moves from position P1 to positions P2, P3, and P4, so that one pixel is increased to four pixels, and the resolution of the image projected by the laser projection apparatus is improved. In some embodiments, the vibrating lens 105 is configured to periodically move at two positions when driven by electric signals.

FIG. 36 is a schematic diagram showing a perspective structure of the vibrating lens and the vibrating lens bracket in FIGS. 4 and 28. Referring to FIG. 36, the vibrating lens 105 is fixed on the vibrating lens bracket 106 through screws, so as to be connected to the vibrating lens bracket 106. Further, the vibrating lens bracket 106 is connected to the housing 1021.

In some embodiments, the vibrating lens 105 and the vibrating lens bracket 106 are flexibly connected, or the vibrating lens bracket 106 and the housing 1021 are flexibly connected.

In some embodiments, the vibrating lens 105 and the vibrating lens bracket 106 are flexibly connected, and the vibrating lens bracket 106 and the housing 1021 are flexibly connected.

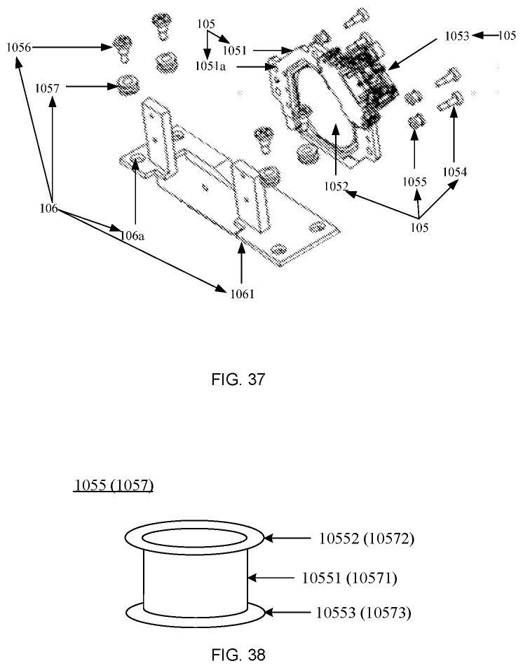

FIG. 37 is a schematic diagram showing an exploded structure of the vibrating lens and the vibrating lens bracket shown in FIG. 36. In some embodiments, referring to FIG. 37, the vibrating lens 105 includes a mounting plate 1051, and a lens 1052 and a lens driving structure 1053 that are fixed to the mounting plate 1051. The vibrating lens 105 is fixedly connected to the vibrating lens bracket 106 through the mounting plate 1051. After receiving the electrical signals, the lens driving structure 1053 is able to periodically vibrate according to the electrical signals, so that the mounting plate 1051 and the lens 1052 fixed on the mounting plate 1051 are driven to periodically vibrate as well.

The vibrating lens 105 further includes four third screws 1054 and four first flexible pads 1055. The mounting plate 1051 includes four mounting plate through holes 1051a. Each third screw 1054 sequentially passes through a first flexible pad 1055 and a mounting plate through hole 1051a in the mounting plate 1051 to be threaded with the vibrating lens bracket 106. In some embodiments, the vibrating lens 105 may include more or less than four third screws, and more or less than four first flexible pads 1055. Correspondingly, the mounting plate 1051 includes more or less than four mounting plate through holes 1051a.

In this case, vibration transmitted from the third screws 1054 to the vibrating lens bracket 106 may be attenuated due to buffer action of the first flexible pads 1055, that is, the vibration transmitted from the vibrating lens 105 to the vibrating lens bracket 106 is attenuated, thereby reducing the noise generated due to the vibration.

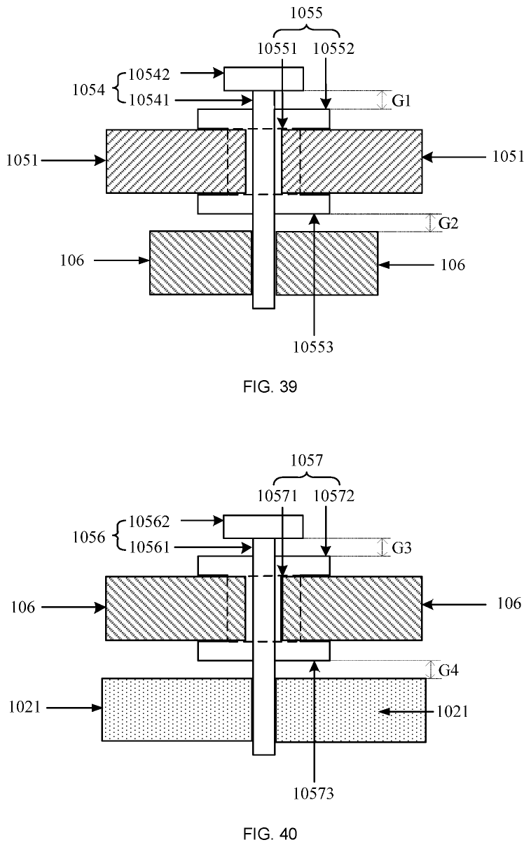

FIG. 38 is a schematic diagram showing a structure of the first flexible pad or a second flexible pad in FIG. 37. In some embodiments, referring to FIG. 38, the first flexible pad 1055 includes a tubular structure 10551 and two annular structures 10552 and 10553 extending from both ends of the tubular structure 10551 respectively. Tubular structures 10551 of the four first flexible pads 1055 are located in the four mounting plate through holes 1051a in one-to-one correspondence, and the two annular structures 10552 and 10553 are located on two surfaces of the mounting plate 1051 penetrated by the mounting plate through holes 1051a respectively.

In a case where a vibration frequency or a vibration amplitude of the vibrating lens 105 is large, the first flexible pad 1055 may not be able to completely block the transmission of the vibration. In this case, the vibration of the vibrating lens 105 is still transmitted to the third screw 1054, then the third screw 1054 transmits the vibration to the first flexible pad 1055, and then the first flexible pad 1055 transmits the vibration to the vibrating lens bracket 106 and even the housing 1021. The vibrating lens bracket 106 and the housing 1021 still vibrate due to influence of the vibration of the vibrating lens 105, and generate loud noise. Or, in a case where a manufacturing precision of the first flexible pads 1055 is not high, degrees of elastic deformation of the first flexible pads 1055 caused by compression after assembly are different, and thus effects of suppressing the noise are also different, which may result in poor uniformity of noise levels of a plurality of laser projection apparatuses. To this end, some embodiments of the present disclosure provide an assembly relationship between the vibrating lens and the vibrating lens bracket, which is described in detail as follows.

FIG. 39 is a schematic sectional view of the vibrating lens and the vibrating lens bracket in FIG. 37 after they are fixed. In some embodiments, as shown in FIG. 39, the third screw 1054 includes a third screw stem 10541 and a third screw head 10542 at an end of the third screw stem 10541. The third screw stem 10541 passes through the tubular structure 10551 of the first flexible pad 1055. There is a first gap G1 between the third screw head 10542 and the annular structure 10552, that is, the mounting plate 1051 is not in contact with the third screw head 10542 of the third screw 1054, so as to reduce a contact area between the third screw 1054 and the first flexible pad 1055, and to increase a degree of the attenuation of the vibration during the transmission. It will be noted that, due to the elastic deformation of the first flexible pad 1055, a structure of the tubular structure 10551 before the elastic deformation is shown in FIG. 39 with dashed lines.

In addition, a second gap G2 may be provided between the vibrating lens 105 and the vibrating lens bracket 106. That is, there is a second gap G2 between the annular structure 10553 close to the vibrating lens bracket 106 in the first flexible pad 1055 and the vibrating lens bracket 106. The second gap G2 causes the vibration to be attenuated to a greater degree during the transmission.

It can be seen therefrom that, since the first flexible pad 1055 is located between the third screw 1055 for fixing the vibrating lens 105 and the mounting plate 1051, vibration on the mounting plate 1051 is attenuated to a great degree due to the buffer action of the first flexible pad 1055 when transmitted to the third screw 1055, so that a frequency or an amplitude of the vibration transmitted from the mounting plate 1051 to the third screw 1054 is reduced. As a result, a frequency or an amplitude of vibration transmitted to the vibrating lens bracket 106 is reduced, and finally a frequency or an amplitude of vibration transmitted from the vibrating lens bracket 106 to the housing 1021 is also reduced, and in turn, the noise generated by the vibrating lens bracket 106 and the housing 1021 is reduced.

In addition, there is the first gap G1 between the annular structure 10552 of the first flexible pad 1055 and the third screw head 10542 of the third screw 1054, and there is the second gap G2 between the annular structure 10553 of the first flexible pad 1055 and the vibrating lens bracket 106. The first gap G1 and the second gap G2 may block the transmission of the vibration to a certain extent, thereby further eliminating the noise generated by the vibrating lens bracket 106 and the housing 1021.

In some embodiments, a size of the first gap G1 between the third screw head 10542 of the third screw 1054 and the annular structure 10552 may be 0.1 mm, and a size of the second gap G2 between the annular structure 10553 of the first flexible pad 1055 and the vibrating lens bracket 106 may also be 0.1 mm. This can not only reduce the noise generated due to the vibration of the vibrating lens 105, but also ensure stability of connection between the third screw 1054 and the mounting plate 1051. Moreover, the first gap G1 of 0.1 mm may also ensure an optical index that the vibrating lens 105 is tilted by one degree (i.e., an included angle between an optical axis of the lens 1052 of the vibrating lens 105 and an optical axis of the projection lens 103), and reduce secondary vibration (i.e., the vibration transmitted by the vibrating lens 105 to the vibrating lens bracket 106 and the housing 1021) induced by the vibration of the vibrating lens to a minimum on a premise of not affecting a quality of the projected image, thereby reducing the noise generated by the laser projection apparatus.

Of course, it can be understood that, values of the first gap G1 and the second gap G2 include but are not limited to 0.1 mm, and may be, for example, 0.2 mm or 0.3 mm, as long as the stability of the connection between the third screw 1054 and the mounting plate 1051, and the optical index that the vibrating lens is tilted by one degree are ensured. The embodiments of the present disclosure do not limit the values of the first gap G1 and the second gap G2.

In some embodiments, the third screw 1054 may be a shoulder screw.

In some embodiments, the first flexible pad 1055 is made of rubber. Rubber is a polymer material with high elasticity (i.e., a middle chain of molecules of the polymer moves due to action of external force, so that long-chain molecules deform and change from a curled shape to a stretched shape; and after the external force is eliminated, the deformation may be completely recovered) and viscoelastictiy; thus, it has a good damping effect and may achieve a purpose of reducing the noise.

Of course, it can be understood that, the first flexible pad 1055 may also be made of any other material with high elasticity and viscoelasticity, which is not limited in the embodiments of the present disclosure.

In some embodiments, as shown in FIG. 37, the vibrating lens bracket 106 includes a bracket body 1061, four fourth screws 1056, and four second flexible pads 1057. The four fourth screws 1056 pass through the four second flexible pads 1057 and the bracket body 1061 to be threaded with the housing 1021. The vibrating lens 105 is fixed on the bracket body 1061, and the bracket body 1061 is connected to the housing 1021 to fix the vibrating lens 105 in the accommodating cavity 1021a enclosed by the housing 1021. The second flexible pads 1057 in the vibrating lens bracket 106 are in contact with the fourth screws 1056 to avoid direct contact between the fourth screws 1056 and the bracket body 1061, so that the vibration of the vibrating lens 105 may be prevented from being transmitted to the bracket body 1061.

In some embodiments, the fourth screws 1056 may be shoulder screws.

A structure of the second flexible pad 1057 is the same as that of the first flexible pad 1055. As shown in FIGS. 37 and 38, the second flexible pad 1057 includes a tubular structure 10571 and two annular structures 10572 and 10573 extending from both ends of the tubular structure 10571 respectively. The bracket body 1061 of the vibrating lens bracket 106 has four vibrating lens bracket through holes 106a. Tubular structures 10571 of the four second flexible pads 1057 are located in the four vibrating lens bracket through holes 106a in one-to-one correspondence. The two annular structures 10572 and 10573 are located on two surfaces of the bracket body 1061 penetrated by the vibrating lens bracket through holes 106a respectively.

In some embodiments, the vibrating lens bracket 106 may include more or less than four fourth screws, and more or less than four second flexible pads. Correspondingly, the vibrating lens bracket 106 includes more or less than four vibrating lens bracket through holes 106a.

FIG. 40 is a schematic sectional view of the vibrating lens bracket in FIG. 37 and the housing after they are fixed. In some embodiments, as shown in FIG. 40, the fourth screw 1056 includes a fourth screw stem 10561 and a fourth screw head 10562 at an end of the fourth screw stem 10561. The fourth screw stem 10561 is located in the tubular structure 10571, and there is a third gap G3 between the fourth screw head 10562 and the annular structure 10572 close to the fourth screw head 10562, so that the fourth screw 1056 does not contact the vibrating lens bracket 106, so as to reduce a contact area between the fourth screw 1056 and the second flexible pad 1057, and to increase the degree of the attenuation of the vibration during the transmission.

In some embodiments, the tubular structures 10571 of the second flexible pads 1057 are located in the vibrating lens bracket through holes 106a, and the fourth screws 1056 pass through the tubular structures 10571 to be connected to the housing 1021, thereby connecting the bracket body 1061 to the housing 1021. When vibration is generated on the bracket body 1061, the vibration is transmitted from the bracket body 1061 to the fourth screw 1056. Since the second flexible pad 1057 is provided between the fourth screw 1056 and the housing 1021, the vibration on the fourth screw 1056 is first transmitted to the second flexible pad 1057, and is attenuated to a great degree due to buffer action of the second flexible pad 1057, so that the frequency or the amplitude of the vibration transmitted from the bracket body 1061 to the housing 1021 is reduced, and the noise generated by the housing 1021 is further reduced. In some embodiments, a fourth gap G4 is provided between the annular structure 10573 of the second flexible pad 1057 and the housing 1021. The fourth gap G4 makes the vibration transmitted from the vibrating lens bracket 106 to the housing 1021 attenuated to a greater degree during the transmission.

In some embodiments, sizes of the third gap G3 and the fourth gap G4 may be 0.1 mm.

Of course, it can be understood that, values of the third gap G3 and the fourth gap G4 include but are not limited to 0.1 mm, and may be, for example, 0.2 mm or 0.3 mm. In some embodiments, a material of the second flexible pad 1057 is the same as the material of the first flexible pad 1055, which will not be repeated herein.

It can be seen therefrom that in some embodiments of the present disclosure, the transmission of the vibration generated by the vibrating lens 105 may be blocked for a first time through the first flexible pad 1055 and the second flexible pad 1057, and the transmission of the vibration may be blocked for a second time through the first gap G1 to the fourth gap G4, thereby reducing the frequency or the amplitude of the vibration generated by the vibrating lens bracket 106 and the housing 102 due to the influence of the vibrating lens, and in turn reducing the noise generated by the vibrating lens bracket 106 and the housing 102.

Additional embodiments including any one or more of the embodiments described above may be provided by the disclosure, where one or more of its components, functionalities or structures is interchanged with, replaced by or augmented by one or more of the components, functionalities or structures of a different embodiment described above.

The foregoing descriptions are merely specific implementations of the present disclosure, but the protection scope of the present disclosure is not limited thereto. Any changes or replacements that a person skilled in the art could conceive of within the technical scope of the present disclosure shall be included in the protection scope of the present disclosure. Therefore, the protection scope of the present disclosure shall be subject to the protection scope of the claims.

1. A laser projection apparatus, comprising:
a laser source configured to provide illumination beams;
an optical engine configured to modulate the illumination beams based on image signals to form projection beams;
a projection lens configured to project the projection beams for imaging; wherein
the optical engine includes a housing, a light pipe, a lens assembly, a reflector, a prism assembly, a digital micromirror device, and at least one prism fixing member;
the housing encloses an accommodating cavity, and at least the light pipe, the lens assembly, the reflector, and the prism assembly are located in the accommodating cavity;
the light pipe is configured to receive the illumination beams and homogenize the illumination beams;
the lens assembly is configured to first amplify the homogenized illumination beams, and then converge the amplified illumination beams and emit the converged illumination beams to the reflector;
the reflector is configured to reflect the illumination beams to the prism assembly;
the digital micromirror device includes a beam receiving surface facing the prism assembly, and is configured to modulate the illumination beams based on the image signals to form the projection beams;
the prism assembly is configured to propagate the illumination beams to the beam receiving surface of the digital micromirror device, and receive the projection beams reflected by the beam receiving surface, and propagate the projection beams to the projection lens; and
the at least one prism fixing member is configured to fix the prism assembly on the housing, so that a relative position of the prism assembly to the projection lens are is kept fixed.

2. The laser projection apparatus according to claim 1, wherein the prism assembly includes a first prism and a second prism;
the first prism is configured to receive the illumination beams from the reflector, and reflect the illumination beams to the beam receiving surface of the digital micromirror device;
the second prism is configured to receive the projection beams reflected by the beam receiving surface and obtained after the modulation, and reflect the projection beams to the projection lens;
the second prism includes at least one prism fixing portion, the at least one prism fixing portion faces the first prism, and an orthogonal projection of the at least one prism fixing portion on a plane perpendicular to an optical axis of the projection lens is not covered by an orthogonal projection of the first prism on the plane; and
the at least one prism fixing member fixes the second prism on the housing through the at least one prism fixing portion, so that a relative position of the second prism to the projection lens are is kept fixed.

3. The laser projection apparatus according to claim 2, wherein the at least one prism fixing member includes at least one of the following:
a first prism fixing member including a bracket and a first elastic sheet connected to the bracket, the bracket being fixedly connected to the housing, and the first elastic sheet abutting against the at least one prism fixing portion; or
a second prism fixing member including a bracket, and a first elastic sheet and a second elastic sheet that are connected to the bracket, the bracket being fixedly connected to the housing, the first elastic sheet abutting against the at least one prism fixing portion, and the second elastic sheet abutting against a non-acting surface for beams at an end of the second prism.

4. The laser projection apparatus according to claim 3, wherein the bracket of the first prism fixing member includes a baffle plate, a bracket fixing portion and a connecting portion;
the baffle plate is disposed opposite to the non-acting surface for the beams at the end of the second prism;
the connecting portion is connected to a side of the baffle plate, and the connecting portion is also connected to the first elastic sheet; and
the bracket fixing portion is connected to another side of the baffle plate, and the bracket fixing portion includes a fixing hole, and the bracket of the first prism fixing member is connected to the housing by installing a corresponding fixing member in the fixing hole.

5. The laser projection apparatus according to claim 3, wherein the bracket of the second prism fixing member includes a baffle plate, a bracket fixing portion and a connecting portion;
the baffle plate is disposed opposite to the non-acting surface for the beams at the end of the second prism;
the connecting portion is connected to a side of the baffle plate, and the connecting portion is also connected to the first elastic sheet; and
the bracket fixing portion is connected to another side of the baffle plate, and the bracket fixing portion includes a fixing hole and the bracket of the first second prism fixing member is connected to the housing by installing a corresponding fixing member in the fixing hole; and
the second elastic sheet is connected to a side of the baffle plate that is not connected to the connecting portion and the bracket fixing portion.

6. The laser projection apparatus according to claim 1, wherein the optical engine further includes a circuit board connected to the digital micromirror device, and a fixing plate for fixing the circuit board;
a surface of the digital micromirror device facing away from the beam receiving surface is a heat dissipation surface, and the heat dissipation surface includes a bearing region and a heat dissipation region;
the fixing plate includes a first opening, the fixing plate is in contact with the circuit board, and the heat dissipation region is exposed from the first opening;
the circuit board includes a second opening, the circuit board is in contact with the bearing region, and the heat dissipation region is exposed from the second opening; and
the fixing plate and the circuit board are connected to the housing through a plurality of first screws.

7. The laser projection apparatus according to claim 6, wherein the optical engine further includes a cooling component configured to dissipate heat of the digital micromirror device;
the cooling component includes a cooling terminal and a fixing terminal connected to the cooling terminal; and
the cooling terminal sequentially passes through the first opening and the second opening to contact the heat dissipation region, and the fixing terminal is connected to the housing through a plurality of second screws.

8. The laser projection apparatus according to claim 7, wherein
a first screw includes a first screw stem, a first screw head at an end of the first screw stem, and a first spring sleeved on the first screw stem; and one end of the first spring abuts against the first screw head, and another end thereof abuts against the fixing plate; and
a second screw includes a second screw stem, a second screw head at an end of the second screw stem, and a second spring sleeved on the second screw stem; and one end of the second spring abuts against the second screw head, and another end thereof abuts against the fixing terminal.

9. The laser projection apparatus according to claim 7, wherein
an orthogonal projection of the fixing terminal of the cooling component on the housing and orthogonal projections of the plurality of first screws on the housing do not overlap; and
an orthogonal projection of the fixing plate on the housing and orthogonal projections of the plurality of second screws on the housing do not overlap.

10. The laser projection apparatus according to claim 7, wherein the plurality of first screws and the plurality of second screws are configured such that:
a sum of a first pressure applied by the plurality of first screws to the fixing plate and a second pressure applied by the plurality of second screws to the cooling component is less than a maximum pressure that the digital micromirror device is able to bear; and
the first pressure is greater than twice of the second pressure, the first pressure is transmitted to the bearing region of the digital micromirror device, and the second pressure is transmitted to the heat dissipation region of the digital micromirror device.

11-12. (canceled)

13. The laser projection apparatus according to claim 1, wherein the optical engine further includes a fixing assembly configured to fix the light pipe on the housing, at least one adjusting screw, and a light pipe bearing assembly;
the light pipe bearing assembly is equipped with the light pipe therein;
a part of the at least one adjusting screw is located in the accommodating cavity enclosed by the housing and abuts against the light pipe bearing assembly, and another part is located outside the accommodating cavity enclosed by the housing; and
the fixing assembly fixes the light pipe bearing assembly in the accommodating cavity enclosed by the housing, the fixing assembly includes at least one adjusting elastic sheet, and the at least one adjusting elastic sheet abuts against an outer side wall of the light pipe bearing assembly, and is arranged symmetrically with the at least one adjusting screw in a length direction of the at least one adjusting screw.

14. The laser projection apparatus according to claim 13, wherein the light pipe bearing assembly includes at least one of the following:
a protruding structure located on at least one side wall of the light pipe bearing assembly, the protruding structure protruding toward an outside of the light pipe bearing assembly, and abutting against a corresponding adjusting elastic sheet; or
a light pipe barrier wall located at an end of the light pipe bearing assembly, in a direction perpendicular to a side wall of the light pipe bearing assembly connected to the light pipe barrier wall, a height of the light pipe barrier wall being smaller than a thickness of the pipe wall of the light pipe; or
a clamping claw located on at least one side wall of the light pipe bearing assembly, the clamping claw including a fixed end and a free end, the fixed end being fixedly connected to or integrally formed with the light pipe bearing assembly, and the free end being bent toward an inside of the light pipe bearing assembly to abut against the light pipe; or
a side wall opening located on a side wall of the light pipe bearing assembly that is provided with no clamping claw.

15. The laser projection apparatus according to claim 13, wherein
the fixing assembly includes two blocking plates connected to each other and two connecting plates connected to the two blocking plates respectively;
the housing includes an L-shaped barrier wall located in the accommodating cavity; and
one connecting plate is fixed on the L-shaped barrier wall, and another connecting plate is fixed on an inner wall of the housing, so that the two blocking plates, the L-shaped barrier wall, and the inner wall of the housing form an accommodating space, and the light pipe bearing assembly is located in the accommodating space.

16. The laser projection apparatus according to claim 15, wherein the L-shaped barrier wall has a step, and the step includes a first step surface, a second step surface, and a connecting surface connecting the first step surface and the second step surface; and
the one connecting plate is fixed on the second step surface, and abuts against the connecting surface.

17. The laser projection apparatus according to claim 15, wherein the at least one adjusting screw includes two adjusting screws, one adjusting screw passes through a side wall of the housing to abut against the light pipe bearing assembly, and another adjusting screw passes through a side wall of the L-shaped barrier wall to abut against the light pipe bearing assembly.

18. The laser projection apparatus according to claim 13, wherein
the light pipe has a beam inlet and a beam outlet, and the illumination beams from the laser source enter the light pipe from the beam inlet, and then are emitted from the beam outlet after being homogenized by the light pipe;
the light pipe bearing assembly includes a positioning notch, and the beam inlet is located at the positioning notch; and
the housing includes an L-shaped positioning structure located in the accommodating cavity, and a portion of the light pipe exposed from the positioning notch abuts against the L-shaped positioning structure.

19. The laser projection apparatus according to claim 1, further comprising a vibrating lens and a vibrating lens bracket,
the vibrating lens and the vibrating lens bracket being located between the prism assembly and the projection lens;
the vibrating lens being configured to periodically vibrate according to received electrical signals, project a projection beam corresponding to a pixel for multiple times, and sequentially inject a plurality of projection beams corresponding to the pixel into the projection lens;
the vibrating lens bracket being configured to fix the vibrating lens to the housing; wherein
the vibrating lens and the vibrating lens bracket are flexibly connected, and/or, the vibrating lens bracket and the housing are flexibly connected.

20. The laser projection apparatus according to claim 19, wherein the vibrating lens includes a mounting plate, a plurality of third screws, and a plurality of first flexible pads;
the mounting plate includes a plurality of mounting plate through holes configured to be connected to the vibrating lens bracket;
a first flexible pad includes a tubular structure in a form of a hollow tube and annular structures extending from both ends of the tubular structure respectively;
the tubular structure is located in a corresponding mounting plate through hole, and the annular structures are located on two surfaces of the mounting plate penetrated by the corresponding mounting plate through hole respectively; and
the plurality of third screws pass through tubular structures in the plurality of mounting plate through holes to be fixedly connected to the vibrating lens bracket.

21. The laser projection apparatus according to claim 20, wherein the vibrating lens bracket further includes a plurality of vibrating lens bracket through holes, a plurality of fourth screws, and a plurality of second flexible pads;
a second flexible pad includes a tubular structure in a form of a hollow tube and annular structures extending from both ends of the tubular structure respectively;
the tubular structure is located in a corresponding vibrating lens bracket through hole, and the annular structures are located on two surfaces of the vibrating lens bracket penetrated by the corresponding vibrating lens bracket through hole respectively; and
the plurality of fourth screws pass through tubular structures in the plurality of vibrating lens bracket through holes to be fixedly connected to the housing.

22. The laser projection apparatus according to claim 21, wherein
a third screw includes a third screw stem and a third screw head at an end of the third screw stem; and there is a gap between the third screw head and an annular structure close to the third screw head, and there is a gap between the vibrating lens bracket and an annular structure close to the vibrating lens bracket; and
a fourth screw includes a fourth screw stem and a fourth screw head at an end of the fourth screw stem; and there is a gap between the fourth screw head and an annular structure close to the fourth screw head, and there is a gap between the housing and an annular structure close to the housing.
